(19) United States
(12) Patent Application Publication
(10) Pub. No.: US 2020/0088979 A1
(43) Pub. Date: Mar. 19, 2020

(54) OPTICAL APPARATUS

(71) Applicant: CANON KABUSHIKI KAISHA, Tokyo (JP)

(72) Inventors: Takefumi Ota, Nagareyama-shi (JP); Ryo Ikuta, Utsunomiya-shi (JP)

(21) Appl. No.: 16/552,282

(22) Filed: Aug. 27, 2019

(30) Foreign Application Priority Data
Sep. 14, 2018 (JP) 2018-172135

(51) Int. Cl. G02B 17/00; G02B 27/09; G02B 26/08

(52) U.S. Cl. CPC G02B 17/002; G02B 7/1821; G02B 26/0816; G02B 27/0977

(57) ABSTRACT

To control a focus position of light at a high speed and with high precision, an optical apparatus includes a first reflection surface 101 configured to be rotatable about a rotational shaft 104 and reflect the light; a second reflection surface 102 configured to be rotatable about the rotational shaft 104, face the first reflection surface 101, and reflect the light from the first reflection surface 101; a third reflection surface 114 that returns the light from the second reflection surface 102 to the second reflection surface 102; and a control unit 120 configured to control a focus position in an optical axis direction of the light returned back to the first reflection surface 101 from the third reflection surface 114 via the second reflection surface 102 by rotating the first and second reflection surfaces 101 and 102 about the rotational shaft 104 in a state in which a relative arrangement between the first and second reflection surfaces 101 and 102 is maintained.

### BACKGROUND OF THE INVENTION

### Field of the Invention

The present invention relates to an optical apparatus and a processing apparatus.

### Description of the Related Art

In various optical systems, one important element in view of improving characteristics of an optical apparatus is to control focus positions of light at a high speed and with high precision. For example, in an optical apparatus that performs work such as marking, piercing, and welding using laser light, controlling focus positions of light from a laser oscillator with high speed and high precision contributes to improvement in quality of the work.

The control of focus positions can be classified into two types of control in an optical axis direction and control in a direction perpendicular to an optical axis.

The control of the focus positions in the optical axis direction is performed, for example, by shifting the position of a condensing lens in an optical system in the optical axis direction. However, since the condensing lens is weighty and is driven by a linear stage, it is difficult to shift the condensing lens at a high speed and with high precision.

The control of the focus positions in the direction perpendicular to the optical axis is performed, for example, by using a so-called fθ lens and changing an angle of light incident on the fθ lens. However, the fθ lens has a problem that a beam diameter at a focus position varies depending on the angle.

Document 1 (D. J. Campbell, P. A. Krug, I. S. Falconer, L. C. Robinson, and G. D. Tait, “Rapid scan phase modulator for interferometric applications” Applied Optics Vol. 20, Issue 2, pp. 335 to 342 (1981)) discloses a technology for rotating two facing mirrors, varying an optical path length, and changing a phase of light. However, the technology disclosed in Document 1 does not relate to the control of focus positions. Accordingly, the optical apparatus disclosed in Document 1 does not include a non-collimating optical system that changes a beam diameter of light in an optical axis direction. In Document 1, since the problem of deviating focus positions does not occur, it is not easy to apply the technology disclosed in Document 1 to an optical apparatus that performs control of focus positions.

On the other hand, Japanese Unexamined Patent Publication No. 2016-103007 discloses a technology for shifting an optical path of light used for laser processing in a direction perpendicular to the optical path using a plurality of four fixed mirrors and one rotatable mirror. However, this technology has a problem that the weight of an optical apparatus increases and optical loss increases since at least five mirrors are necessary.

Additionally, Document 2 (Meng-Chang Hsieh, Jiun-You Lin and Chia-Ou Chang, “Using a Hexagonal Mirror for Varying Light Intensity in the Measurement of Small-Angle Variation” Sensors 2016, 16, 1301) discloses a technology for reflecting light using a hexagonal mirror, but does not relate to control of focus positions. A technology for shifting an optical path of incident light in a direction perpendicular to the optical path using a refractive index medium is known. However, in this technology, optical loss increases due to the refractive index medium. Further, when the refractive index medium is used, the size of the refractive index medium has to be large to realize a large shift amount. As a result, this technology is disadvantageous in view of weight and high-speed shift.

### SUMMARY OF THE INVENTION

An aspect of the present invention is to propose an optical apparatus advantageous to control of focus positions of light at a high speed and with high precision.

According to an aspect of the present invention, an optical apparatus controlling a focus position of light includes: a first reflection surface configured to be rotatable about a rotational shaft and reflect the light; a second reflection surface configured to be rotatable about the rotational shaft, face the first reflection surface, and reflect the light from the first reflection surface; a third reflection surface that returns the light from the second reflection surface to the second reflection surface; and a control unit configured to control a focus position in an optical axis direction of the light returned back to the first reflection surface from the third reflection surface via the second reflection surface by rotating the first and second reflection surfaces about the rotational shaft in a state in which a relative arrangement between the first and second reflection surfaces is maintained.

Further features of the present invention will become apparent from the following description of exemplary embodiments with reference to the attached drawings.

### BRIEF DESCRIPTION OF THE DRAWINGS

FIGS. 1A to 1C are diagrams illustrating an optical apparatus that includes a focus position shifter in a first embodiment.

FIG. 2 is a diagram illustrating a principle of control of focus positions in an optical axis direction in the first embodiment.

FIG. 3 is a diagram illustrating a second embodiment of the optical apparatus.

FIG. 4 is a diagram illustrating a third embodiment of the optical apparatus.

FIG. 5 is a diagram illustrating a fourth embodiment of the optical apparatus.

FIG. 6 is a diagram illustrating a fifth embodiment of the optical apparatus.

FIG. 7 is a diagram illustrating a sixth embodiment of the optical apparatus.

FIG. 8 is a diagram illustrating a seventh embodiment of the optical apparatus.

FIG. 9 is a diagram illustrating an eighth embodiment of the optical apparatus.

FIG. 10 is a diagram illustrating a ninth embodiment of the optical apparatus.

FIGS. 11A to 11E are diagrams illustrating a tenth embodiment of the optical apparatus.

FIG. 12 is a diagram illustrating a principle of control of a focus position in a direction perpendicular to an optical axis in the tenth embodiment.

FIG. 13 is a diagram illustrating an eleventh embodiment of the optical apparatus.

FIG. 14 is a diagram illustrating a twelfth embodiment of the optical apparatus.

FIG. 15 is a diagram illustrating a thirteenth embodiment of the optical apparatus.

FIG. 16 is a diagram illustrating a fourteenth embodiment of the optical apparatus.

FIG. 17 is a diagram illustrating a fifteenth embodiment of the optical apparatus.

FIG. 18 is a diagram illustrating a sixteenth embodiment of the optical apparatus.

FIG. 19 is a diagram illustrating a seventeenth embodiment of the optical apparatus.

FIG. 20 is a diagram illustrating an eighteenth embodiment of the optical apparatus.

FIG. 21 is a diagram illustrating a nineteenth embodiment of the optical apparatus.

FIG. 22 is a diagram illustrating an example of a processing apparatus using one of the embodiments of the optical apparatus.

### DESCRIPTION OF THE EMBODIMENTS

### First Embodiment

Hereinafter, a first embodiment for carrying out the present invention will be described with reference to the drawings.

In each drawing, the same reference numerals are given to the same members and elements and repeated description will be omitted. In the following description, a direction in which an optical axis extends is referred to as an optical axis direction. In an optical apparatus to be described below, a focus position shifter is used to control focus positions of light at a high speed and with high precision. That is, the optical apparatus controls focus positions of light emitted from the focus position shifter in an optical axis direction and focus positions in a direction perpendicular to the optical axis of the light.

First, a technology for controlling focus positions in an optical axis direction using a focus position shifter according to the first embodiment will be described.

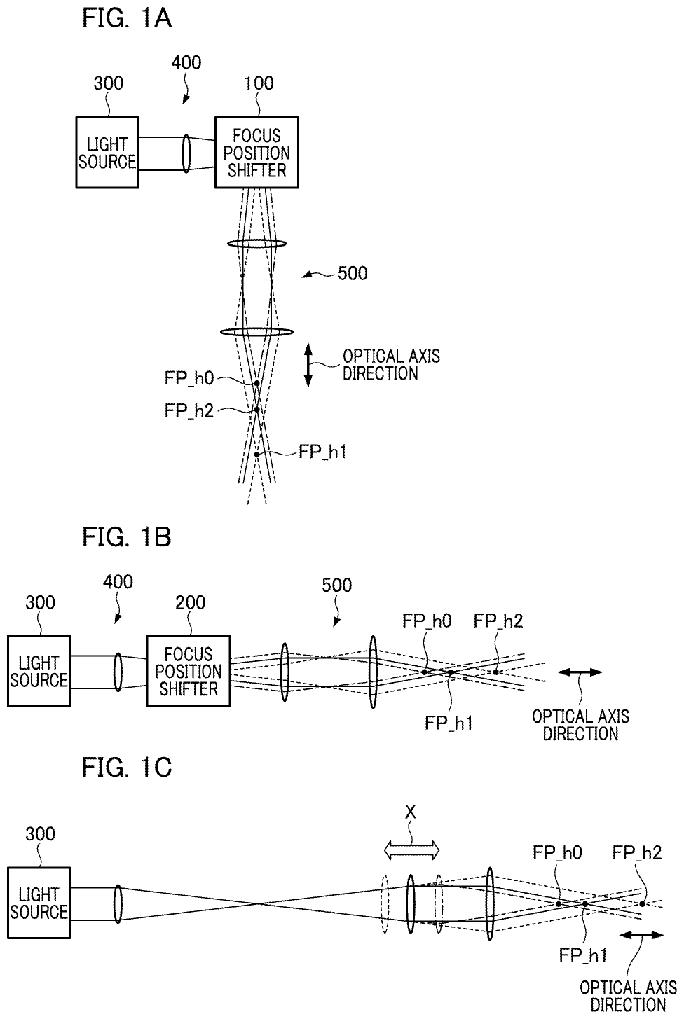

FIGS. 1A to 1C are diagrams illustrating the first embodiment of an optical apparatus that includes a focus position shifter.

FIG. 1A illustrates an example in which an optical axis of light incident from a light source 300 to a focus position shifter 100 and an optical axis of light emitted from the focus position shifter 100 in the downward direction of the drawing are in different directions. Here, that directions are different means that the optical axis of the light emitted from the focus position shifter 100 has a slope equal to or greater than 45° and equal to or less than 135° (for example, an angle of 90°) with respect to the optical axis of the light incident on the focus position shifter 100.

FIG. 1B illustrates an example in which an optical axis of light incident on the focus position shifter 200 and the optical axis of light emitted from the focus position shifter 200 are the same direction. Here, that directions are the same means that the optical axis of the light emitted from the focus position shifter 200 is within a range equal to or greater than 0° (parallel) and less than 45° with respect to the optical axis of the light incident on the focus position shifter 200.

FIG. 1C illustrates a comparison example. In the comparison example, as indicated by X in the drawing, focus positions FP_h0, FP_h1, and FP_h2 in the optical axis direction are controlled by shifting the position of a condensing lens 118 in the optical axis direction. In such a configuration, however, since the condensing lens 118 is weighty and is driven by a linear stage, it is difficult to shift the condensing lens 118 at a high speed and with high precision.

In contrast, the focus position shifters 100 and 200 illustrated in FIGS. 1A and 1B each control the focus positions FP_h0, FP_h1, and FP_h2 in the optical axis direction by controlling an optical path length of light without driving a condensing lens.

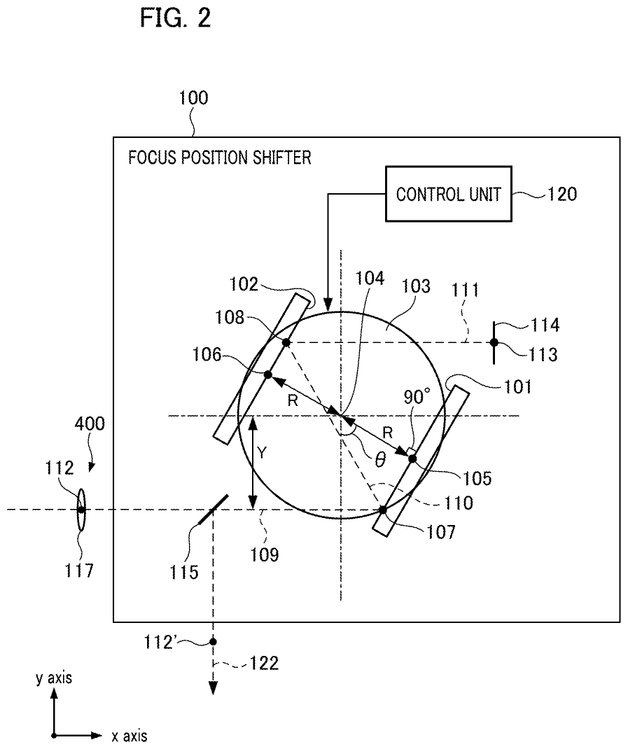

For example, light from the light source 300 enters into the focus position shifter 100 or 200 via a non-collimating optical system 400. Here, the non-collimating optical system is an optical system that changes collimated light (parallel light) from the light source 300 into non-collimated light (convergent light or diffused light) with a beam diameter varying as the light propagates in the optical axis direction. In this example, the non-collimating optical system 400 includes a condensing lens 117 shown in FIG. 2 generating convergent light, but the present invention is not limited thereto and a diffracting grating or a concave (or convex) mirror may be used. The light source 300 is, for example, a laser oscillator and light from the light source 300 is, for example, a laser beam.

The light emitted from the focus position shifter 100 or 200 forms a focus point at a predetermined position via an optical system 500 that forms a focus point. The optical system 500 is, for example, a convergent optical system that converges light emitted from the focus position shifter 100 or 200. The optical system 500 has the following advantage since the optical system 500 is provided, although the optical system 500 is not necessarily required.

In this example, the focus position shifter 100 or 200 changes focus positions of light emitted from the focus position shifter 100 or 200 by varying the optical path length of the light incident from the non-collimating optical system 400. In this case, the light from the condensing lens 117 may change from convergent light to diffused light in some cases since a spot of the light is formed during propagation of the light inside the focus position shifter 100 or 200. In these cases, the optical system 500 that converges again the diffused light emitted from the focus position shifter 100 or 200 to form the convergent light is necessary.

That is, when the optical system 500 performs control of focus positions in the optical axis direction by controlling the optical path length using the focus position shifter 100 or 200, the optical system 500 has the advantage of reliably forming focus points of light emitted from the focus position shifter 100 or 200.

FIG. 2 is a diagram illustrating a principle of control of focus positions in an optical axis direction in the first embodiment.

The focus position shifter 100 performs control of focus positions in the optical axis direction. The focus position shifter 100 controls focus positions of light emitted from the focus position shifter 100 in the optical axis direction by varying the optical path length of the light incident from the non-collimating optical system 400.

Therefore, the focus position shifter 100 includes a first reflection surface 101, a second reflection surface 102 facing the first reflection surface 101, a third reflection surface 114 that returns back light, a fourth reflection surface 115 that extracts light, and a control unit 120.

The first reflection surface 101, the second reflection surface 102, the third reflection surface 114, and the fourth reflection surface 115 are, for example, mirrors. Here, the fourth reflection surface 115 has a property of transmitting light from the non-collimating optical system 400 and reflecting light from the first reflection surface 101. In this example, for convenience's sake, it is assumed that the first reflection surface 101 and the second reflection surface 102 are parallel to each other. However, the first reflection surface 101 and the second reflection surface 102 may not be parallel to each other as long as the first reflection surface 101 and the second reflection surface 102 face each other.

Here, it is regarded that the first reflection surface 101 and the second reflection surface 102 face each other if an angle α formed between the first reflection surface 101 and the second reflection surface 102 is within a range equal to or greater than 0° (parallel) and less than 90°. This is because it is necessary to be able to reflect the light from the first reflection surface 101 by the second reflection surface 102, as will be described below.

The first reflection surface 101 and the second reflection surface 102 are configured to rotate together about a rotational shaft 104. It is necessary for the first reflection surface 101 and the second reflection surface 102 to rotate together about the rotational shaft 104 in a state in which a relative arrangement (relative angle and relative position) between the first reflection surface 101 and the second reflection surface 102 is maintained. Therefore, the focus position shifter 100 includes, for example, a stage 103 that can rotate about the rotational shaft 104. In this case, the first reflection surface 101 and the second reflection surface 102 are fixed to the stage 103. The control unit 120 varies the optical path length of light incident from the non-collimating optical system 400 by changing a rotational angle of the stage 103 and controls focus positions of light emitted from the focus position shifter 100 in the optical axis direction.

The rotational shaft 104 may be in a region between the first reflection surface 101 and the second reflection surface 102 or may be in a region other than the region between the first reflection surface 101 and the second reflection surface 102, as will be described below.

The first reflection surface 101 reflects light from the non-collimating optical system 400. The light reflected from the first reflection surface 101 goes toward the second reflection surface 102 and is reflected by the second reflection surface 102. The third reflection surface 114 returns the light from the second reflection surface 102 to the second reflection surface 102. That is, the light from the non-collimating optical system 400 via an optical path 109, an optical path 110, and an optical path 111 in sequence is returned back by the third reflection surface 114. The light returned back by the third reflection surface 114 is reflected by the fourth reflection surface 115 to be emitted via the same optical paths, that is, the optical path 111, the optical path 110, and the optical path 109 in sequence.

By using the focus position shifter 100, and by controlling, for example, a rotational angle of the stage 103 by the control unit 120, the optical path length of the light inside the focus position shifter 100 can be varied. Accordingly, it is possible to control the focus positions of light 122 emitted from the focus position shifter 100 in the optical axis direction.

A variation of the optical path length inside the focus position shifter 100 will be described.

In the following description, a central point of the condensing lens 117 is assumed to be an incidence point 112 of light, where (xᵢ, yᵢ) are the coordinates of the incidence point 112. A point on the third reflection surface 114 by which the light from the second reflection surface 102 is reflected is assumed to be an intermediate point 113, where (xₒ, yₒ) are the coordinates of the intermediate point 113. Further, a point at which the light returned back from the third reflection surface 114 is emitted is assumed to be an emission point 112′, and an optical path length from the incidence point 112 to the intermediate point 113 is assumed to be the same as an optical path length from the intermediate point 113 to the emission point 112′.

In addition, (x₀₁, y₀₁) are the coordinates of an intersection 105 of the first reflection surface 101 and a perpendicular line drawn from the rotational shaft 104 to the first reflection surface 101 and (x₀₂, y₀₂) are the coordinates of an intersection 106 of the second reflection surface 102 and a perpendicular line drawn from the rotational shaft 104 to the second reflection surface 102. A length R of the perpendicular line drawn from the rotational shaft 104 to the first reflection surface 101 is assumed to be the same as a length R of the perpendicular line drawn from the rotational shaft 104 to the second reflection surface 102. That is, a distance between the first reflection surface 101 and the second reflection surface 102 is assumed to be 2R.

When a perpendicular line is drawn from the rotational shaft 104 to the optical path (incidence optical axis) 109, the length of the perpendicular line is assumed to be Y. That is, light incident on the non-collimating optical system 400 is incident on the first reflection surface 101 with an offset distance Y from the rotational shaft 104. A state in which the first reflection surface 101 is parallel to the optical path (the incidence optical axis) 109 is defined as a rotational angle 0°. Here, at the rotational angle 0°, the first reflection surface 101 is assumed to be closer to the optical path (incidence optical axis) 109 than the second reflection surface 102.

The stage 103 is assumed to be rotated counterclockwise by an angle θ from the rotational angle 0° when the state of the rotational angle 0° is set as a reference. The rotational angle θ is controlled within a range of, for example, 0° to 90°. Accordingly, a motor that rotates the stage 103 is preferably a galvano-motor that can rotate the stage 103 counterclockwise or clockwise. Here, the motor that rotates the stage 103 may be a rotational motor that can rotate the stage 103 only unidirectionally (for example, counterclockwise). In this case, when the rotational angle θ is reduced, the rotational angle θ may be controlled again from the state of the rotational angle 0° after one revolution of the stage 103.

On the above premise, first, the coordinates (x₀₁, y₀₁) of the intersection 105 and the coordinates (x₀₂, y₀₂) of the intersection 106 are as expressed in Expressions (1) to (4) below.

$$\begin{matrix}{x}_{01} = R \times cos ( θ - \frac{π}{2} ) = R \times sin ( θ ) & ( 1 ) \\ {y}_{01} = R \times sin ( θ - \frac{π}{2} ) = - R \times cos ( θ ) & ( 2 ) \\ {x}_{02} = R \times cos ( θ + \frac{π}{2} ) = - R \times sin ( θ ) & ( 3 ) \\ {y}_{02} = R \times sin ( θ + \frac{π}{2} ) = R \times cos ( θ ) & ( 4 )\end{matrix}$$

Next, when (x₁, y₁) are coordinates on the first reflection surface 10 and (x₂, y₂) are coordinates on the second reflection surface 102, relations shown in Expressions (5) and (6) below can be obtained.

y₁−y₀₁=(tan θ)×(x₁−x₀₁) (5)

y₂−y₀₂=(tan θ)×(x₂−x₀₂) (6)

Next, (xₘ₁, yₘ₁) are coordinates of a point 107 on the first reflection surface 101 that reflects light from the non-collimating optical system 400 and (xₘ₂, yₘ₂) are coordinates of a point 108 on the second reflection surface 102 that reflects light from the first reflection surface 101. y_{B1} is the y coordinate on the optical path 109 between the non-collimating optical system 400 and the first reflection surface 101 and (x_{BR}, y_{BR}) are coordinates on the optical path 110 between the first reflection surface 101 and the second reflection surface 102. In this case, coordinates on the optical path 110 between the first reflection surface 101 and the second reflection surface 102 can be as shown in Expression (7) below.

y_{BR}−yₘ₁=tan(2θ) (7)

Next, y_{BO} is the y coordinate on the optical path 111 of light reflected by the second reflection surface 102. In this case, the coordinates (xₘ₁, yₘ₁) of the reflection point 107 and the coordinates (xₘ₂, yₘ₂) of the reflection point 108 are as expressed in Expressions (8) to (11) below.

$$\begin{matrix}{x}_{m 1} = \frac{Y}{tan θ} + \frac{R}{sin θ} & ( 8 ) \\ {y}_{m 1} = Y & ( 9 ) \\ {x}_{m 2} = \frac{Y}{tan θ} + 2 R \times \frac{1}{sin ( θ )} \times \frac{tan ( 2 θ )}{tan ( 2 θ ) - tan ( θ )} - \frac{R}{sin ( θ )} & ( 10 ) \\ {y}_{m 2} = Y + 2 R \times \frac{1}{sin ( θ )} \times \frac{tan ( 2 θ ) \times tan ( θ )}{tan ( 2 θ ) - tan ( θ )} & ( 11 )\end{matrix}$$

Next, when (xᵢ, yᵢ) are the coordinates of the incidence point 112 of light and (xₒ, yₒ) are the coordinates of a middle point 113 of the light, the length of the optical path 109, that is, a length from the coordinates (xᵢ, yᵢ) to the coordinates (xₘ₁, yₘ₁), is as expressed in Expression (12) below.

$$\sqrt{{( {x}_{m 1} - {x}_{i} )}^{2} + {( {y}_{m 1} - {y}_{i} )}^{2}} = \vert \frac{Y}{tan θ} + \frac{R}{sin θ} - {x}_{i} \vert \qquad ( 12 )$$

The length of the optical path 110, that is, a length from the coordinates (xₘ₁, yₘ₁) to the coordinates (xₘ₂, yₘ₂) is as expressed in Expression (13) below.

$$\sqrt{{( {x}_{m 2} - {x}_{m 1} )}^{2} + {( {y}_{m 2} - {y}_{m 1} )}^{2}} = \vert 2 R \times \frac{1}{tan ( 2 θ ) - tan ( θ )} \times \frac{1}{cos ( θ ) \times cos ( 2 θ )} \vert \qquad ( 13 )$$

Further, the length of an optical path 111, that is, a length from the coordinates (xₘ₂, yₘ₂) to the coordinates (xₒ, yₒ), is as expressed in Expression (14) below.

$$\sqrt{{( {x}_{o} - {x}_{m 2} )}^{2} + {( {y}_{o} - {y}_{m 2} )}^{2}} = \vert {x}_{o} - ( \frac{Y}{tan θ} + 2 R \times \frac{1}{sin ( θ )} \times \frac{tan ( 2 θ )}{tan ( 2 θ ) - tan ( θ )} - \frac{R}{sin ( θ )} ) \vert \qquad ( 14 )$$

Accordingly, an optical path length from the incidence point 112 of the light to the middle point 113, that is, a length from the coordinates (xᵢ, yᵢ) to the coordinates (xₒ, yₒ), is as expressed in Expression (15) below.

l=4R·sin θ−xᵢ+xₒ (15)

Here, it is assumed that light from the second reflection surface 102 is returned back again to the second reflection surface 102 by the third reflection surface 114 without shifting the optical axis. In this case, since the optical path length from the incidence point 112 to the middle point 113 is equal to an optical path length from the middle point 113 to the emission point 112′, an optical path length from the incidence point 112 to the emission 112′ is as expressed in Expression (16) below.

2×l=8×R·sin θ−xᵢ+2×xₒ+Δ (16)

Here, Δ is a shift amount of an optical axis in the third reflection surface 114. As described above, Δ is zero when it is assumed that there is no shift of an optical axis in the third reflection surface 114.

As is apparent from Expression (16), the optical path length varies depending on the rotational angle θ of the stage 103. That is, by controlling the rotational angle θ, it is possible to control an optical path length of light in the focus position shifter 100 and control a focus position of the light emitted from the focus position shifter 100 in the optical axis direction. When a distance (2×R) between the first reflection surface 101 and the second reflection surface 102 is set to be large, a variation amount of the optical path length with respect to the rotational angle θ can be set to be large.

For example, by rotationally driving the stage 103 using a galvano-motor, it is possible to control the focus position of the light in the optical axis direction at a higher speed and with higher precision than when the condensing lens 117 is linearly driven. The size of the first reflection surface 101 and the size of the second reflection surface 102 may be the same or may be different from each other. In the latter case, as will be described below, the first reflection surface 101 is preferably smaller than the second reflection surface 102 in size.

In the foregoing description, it is assumed that the first reflection surface 101 and the second reflection surface 102 are parallel to each other, but the above-described principle can be applied even when the first reflection surface 101 and the second reflection surface 102 are nonparallel to each other.

For example, when it is assumed that the first reflection surface 101 deviates from the second reflection surface 102 by an angle α, an optical axis of light along the optical path 111 deviates from the optical axis of light along the optical path 109 by (2×α). However, since the optical axis of light along the optical path 111 does not depend on the rotational angle θ, the light from the second reflection surface 102 is shifted in parallel despite a change in the rotational angle θ. That is, even when the rotational angle θ is changed, the relation in which the optical axis of light along the optical path 111 deviates from the optical axis of light along the optical path 109 by (2×α) is constant. Accordingly, when the third reflection surface 114 reflects reflected light to the same optical path as the optical path of incident light, the returned light returns to the optical path 109 again.

This means that the above-described principle can be applied even when the first reflection surface 101 and the second reflection surface 102 are nonparallel to each other. In other words, this means that the parallelism may not be set precisely even though it is assumed that the first reflection surface 101 and the second reflection surface 102 are parallel to each other. In accordance with a reflection angle of light by the third reflection surface 114, it is possible to compensate for a variation in the parallelism at reflection positions of the first reflection surface 101 and the second reflection surface 102.

### Second Embodiment

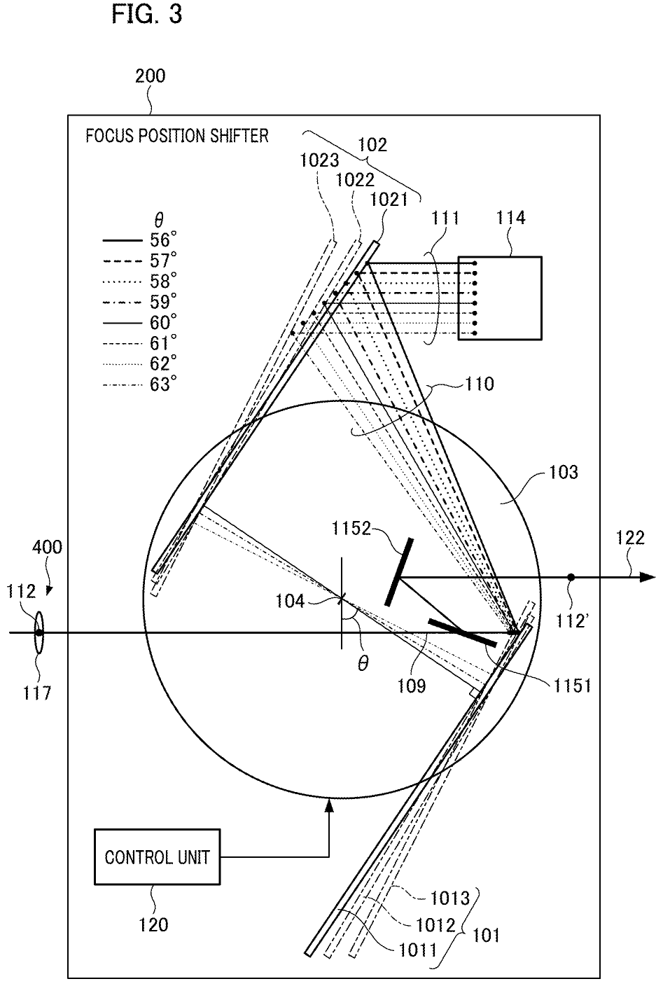

FIG. 3 is a diagram illustrating a second embodiment which is a specific example of the optical apparatus 200 in FIG. 1B.

This embodiment explains examples of optical paths when the rotational angle θ of the stage 103 is changed in units of 1° within a range of 56° to 63°.

First reflection surfaces 1011, . . . , 1012, . . . , and 1013 are disposed at positions of 25 mm from the rotational shaft 104 (coordinates (0, 0)) and the second reflection surfaces 1021, . . . , 1022, . . . , and 1023 are also disposed at positions of 25 mm from the rotational shaft 104. The first reflection surface 1011 and the second reflection surface 1021 correspond to the case of the rotational angle θ of 56° and are disposed to be parallel to each other. The first reflection surface 1012 and the second reflection surface 1022 correspond to the case of the rotational angle θ of 59° and are disposed to be parallel to each other. The first reflection surface 1013 and the second reflection surface 1023 correspond to the case of the rotational angle θ of 63° and are disposed to be parallel to each other.

The sizes of the first reflection surfaces 1011, . . . , 1012, . . . , and 1013 and the sizes of the second reflection surfaces 1021, 1022, and 1023 are the same and are, for example, 120 mm. In this example, the sizes of the first reflection surfaces 1011, 1012, . . . , and 1013 and the sizes of the second reflection surfaces 1021, . . . , 1022, . . . , and 1023 are assumed to be sizes (widths) in a direction parallel to the upper surface of the stage 103.

Here, the optical axis direction of light along the optical path 109 is referred to as an x axis and a direction perpendicular thereto is referred to as a y axis. The condensing lens 117 is disposed at a position of 10 mm in the x direction and −5 mm in the y direction from the rotational shaft 104. The third reflection surface 114 is disposed at a position of 20 mm in the x direction from the rotational shaft 104. The third reflection surface 114 is, for example, a mirror that has two reflection surfaces perpendicular to each other. That is, light from the second reflection surfaces 1021, . . . , 1022, . . . , and 1023 is reflected from one of the two reflection surfaces and is subsequently reflected by the other of the two reflection surfaces. Thereafter, the light is returned back from the third reflection surface 114 to the second reflection surfaces 1021, . . . , 1022, . . . , and 1023.

As described above, when the third reflection surface 114 is a mirror that has two reflection surfaces perpendicular to each other, the optical paths 109, 110, and 111 serving as a forward path can be slightly displaced from the optical paths 111, 110, and 109 serving as a return path. Accordingly, there is no concern of interference between light propagating along the optical paths 109, 110, and 111 serving as the forward path and light propagating along the optical paths 111, 110, and 109 serving as the return path. Here, in this case, since A of Expression (16) is not zero, it is necessary to consider Δ at a focus position in the optical axis direction.

Instead of the mirror that has the two reflection surfaces, the third reflection surface 114 may be one mirror that reflects light to the same optical path as the optical path of incident light.

Fourth reflection surfaces 1151 and 1152 extract the emitted light 122 in the same direction as the optical axis of the incident light on the optical path 109, that is, the x direction. Here, the fourth reflection surfaces 1151 and 1152 may be disposed to extract the emitted light 122 in a direction intersecting the optical axis of the incident light on the optical path 109, for example, in the y direction.

The collimated light is incident on the condensing lens 117 from the light source 300 and a focal distance of the condensing lens 117 is 200 mm. The stage 103 is driven by the galvano-motor and the rotational angle θ is controlled within a range of 56° to 63°. In the drawing, an optical path is illustrated at intervals of 1° so that the optical path is easily seen. A rotational speed of the stage 103 by the galvano-motor can be set to about 1 revolution per second (1 Hz=1 rps).

Under the foregoing conditions, an optical path length can be changed within a range from 151.5 mm to 156.5 mm. A movement speed of the focus position when the rotational angle θ is changed from 59° to 62° is 5 mm/(3/360)=600 mm/ms. In focus shift by a linear motion of a lens disposed on a linear stage in the related art, a movement speed of a focus position is about 200 mm/ms. That is, according to this example, it is possible to control a focus position at a high speed and with high precision.

In this example, the fourth reflection surface 1151 is disposed at a position of 10 mm in the x direction from the condensing lens 117 and the fourth reflection surface 1152 is disposed at a position of −10 mm in the x direction from the fourth reflection surface 1151. This is a contrivance for preventing an optical path of light extracted from the focus position shifter 200 from interfering to the first reflection surfaces 1011, . . . , 1012, . . . , and 1013. Since a focal distance of the condensing lens 117 is 200 mm, a focus point is formed at a position of about 45 mm to 50 mm in the x direction from the fourth reflection surface 1152.

According to the second embodiment, by controlling the optical path length in this way, it is possible to control a focus position of light in the optical axis direction at a high speed and with high precision.

When one mirror is used as the third reflection surface 114 and the third reflection surface 114 reflects light to the same optical path as incident light, a beam splitter is preferably inserted immediately before the first reflection surfaces 1011, . . . , 1012, . . . , and 1013.

Light from the non-collimating optical system 400 may be converted into a linearly polarized light beam by a wavelength plate, may be converted into a circularly polarized light beam by a polarization beam splitter and a quarter-wavelength plate, and may be subsequently incident on the first reflection surfaces 1011, . . . , 1012, . . . , and 1013. In this case, by converting light returned back from the third reflection surface 114 into a linearly polarized light beam of which polarization is rotated by 90 degrees again by the quarter-wavelength plate, it is possible to extract the linearly polarized light beam by the polarization beam splitter.

The stage 103 is a disc, but may be a part of a disc, a rod-like shape, or any other shape in view of a reduction in weight or the like. Here, in any shape, it is necessary to realize a structure in which the rotational shaft 104 is physically connected to the first reflection surfaces 1011, . . . , 1012 . . . , and 1013 and the second reflection surfaces 1021, . . . , 1022, . . . , and 1023.

### Third Embodiment

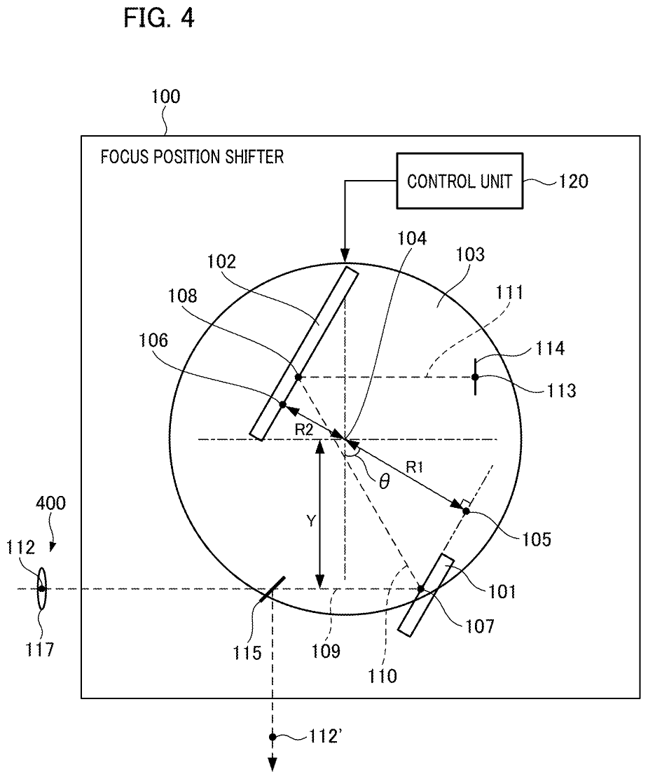

FIG. 4 is a diagram illustrating a third embodiment which is a specific example of the optical apparatus in FIGS. 1A to 1C.

As described above, the size of the first reflection surface 101 may not be the same as the size of the second reflection surface 102. Accordingly, in this example, an example in which the size of the first reflection surface 101 is set to be smaller than the size of the second reflection surface 102 and, for example, the weight of the stage 103 driven by a galvano-motor is reduced will be described.

In this case, since a load on the galvano-motor is reduced, the stage 103 can be rotated at a high speed. This means that the focus position shifter 100 can control a focus position at a high speed and with high precision.

When the coordinate xₘ₁ indicated in Expression (8) is differentiated with respect to the rotational angle θ, the following expression is obtained.

$$\frac{{dx}_{m 1}}{d θ} = - \frac{1}{{cos}^{2} θ} \cdot ( Y + R cos θ ) . \qquad ( 17 )$$

When Expression (17) is 0 at a central angle θ₀ of the controllable rotational angle θ, a displacement of xₘ₁ is the smallest. Accordingly, a relational expression indicated in Expression (18) can be obtained.

$$- \frac{1}{{cos}^{2} θ} \cdot ( Y + R cos θ ) = 0 \\ ⇔ cos θ = \frac{Y}{R} \qquad ( 18 )$$

Accordingly, when θ=θ₀, the coordinates (x₀₁, y₀₁) of the intersection 105 of the perpendicular line drawn from the rotational shaft 104 to the plane including the first reflection surface 101 and the plane are matched with coordinates (xₘ₁, yₘ₁) of a point 107 at which incident light is reflected from the first reflection surface 101. In this case, it is not necessary to increase the size of the first reflection surface 101 to cover displacement of xₘ₁. That is, by causing the size of the first reflection surface 101 to be smaller than the size of the second reflection surface 102, it is possible to reduce the weight of the stage 103. Since the coordinates (x₀₁, y₀₁) of the intersection 105 are matched with coordinates (xₘ₁, yₘ₁) of the reflection point 107 at θ=θ₀, the center of gravity on the stage 103 is easily stabilized, which also contributes to high-speed control of a focus position.

The configuration of the optical apparatus in this example is basically the same as the configuration of the first embodiment. Here, the condensing lens 117 is disposed at a position of −10 mm in the x direction and −12.3 mm in the y direction from the rotational shaft 104 so that Expression (17) becomes 0 at θ₀=60.5°. As a result, in the direction parallel to the upper surface of the stage 103, the size (width) of the first reflection surface 101 can be set to 4 mm and the size of the second reflection surface 102 can be set to 13 mm.

In this example, a length R1 of the perpendicular line drawn from the rotational shaft 104 to a plane including the first reflection surface 101 is different from a length R2 of the perpendicular line drawn from the rotational shaft 104 to the second reflection surface 102. In this case, the coordinates (x₀₁, y₀₁) of the intersection 105 and the coordinates (x₀₂, y₀₂) of the intersection 106 are as expressed in Expressions (19) to (22) below.

$$\begin{matrix}{x}_{01} = {R}_{1} \times cos ( θ - \frac{π}{2} ) = {R}_{1} \times sin ( θ ) & ( 19 ) \\ {y}_{01} = {R}_{1} \times sin ( θ - \frac{π}{2} ) = - {R}_{1} \times cos ( θ ) & ( 20 ) \\ {x}_{02} = {R}_{2} \times cos ( θ + \frac{π}{2} ) = - {R}_{2} \times sin ( θ ) & ( 21 ) \\ {y}_{02} = {R}_{2} \times sin ( θ + \frac{π}{2} ) = {R}_{2} \times cos ( θ ) & ( 22 )\end{matrix}$$

In this case, an optical path length is as follows.

2×l=4×(R₁+R₂)·sin θ−xᵢ−2×xₒ+Δ (23)

When Expression (16) is compared to Expression (23), it can be understood that a change in the optical path length does not depend on a distance from the rotational shaft 104, but depends on a distance (2R or R1+R2) between the first reflection surface 101 and the second reflection surface 102. In this example, as described above, the size of the second reflection surface 102 is greater than the size of the first reflection surface 101. Accordingly, in this example, the second reflection surface 102 is disposed at a position closer to the rotational shaft 104 than the first reflection surface 101.

As described above, according to the third embodiment, a load on the galvano-motor is reduced. Therefore, the stage 103 can be rotated at a high speed and the focus position shifter 100 controls a focus position at a high speed and with high precision.

### Fourth Embodiment

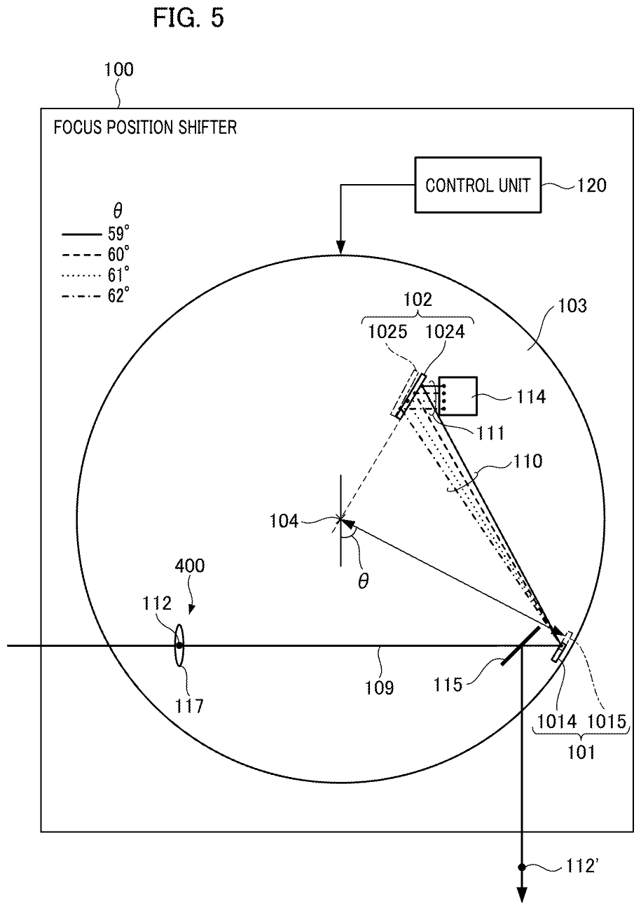

FIG. 5 is a diagram illustrating a fourth embodiment which is a specific example of the optical apparatus in FIG. 1.

The fourth embodiment is an example in which the first reflection surface 101 and the second reflection surface 102 are not disposed to be point-symmetric to the rotational shaft 104.

In this example, the length of a perpendicular line drawn from the rotational shaft 104 to the first reflection surface 101 or a plane including the first reflection surface 101 is set to 50 mm. The length of a perpendicular line drawn from the rotational shaft 104 to the second reflection surface 102 or a plane including the second reflection surface 102 is set to 0 mm. That is, the rotational shaft 104 is included in the second reflection surface 102 or the plane including the second reflection surface 102. The condensing lens 117 is disposed at a position of 40 mm in the x direction and −25 mm in the y direction from the rotational shaft 104. Further, the third reflection surface 114 returning back light is disposed at a position of 30 mm in the x direction from the rotational shaft 104.

The control unit 120 causes the galvano-motor to rotationally drive the stage 103. The control unit 120 controls a rotational angle of the stage 103 within a range of 59° to 62°. A rotational speed of the stage 103 by the galvano-motor is set to, for example, about 1 revolution per second (1 Hz=1 rps).

Under the foregoing conditions, an optical path length can be changed within a range from 151.5 mm to 156.5 mm. For example, when the rotational angle θ is 59°, the light is reflected from a first reflection surface 1014 and a second reflection surface 1024 and an optical path length is 156.5 mm. When the rotational angle θ is 62°, the light is reflected by a first reflection surface 1015 and a second reflection surface 1025 and an optical path length is 151.5 mm.

In this example, it is possible to control the focus position at a high speed and with high precision and it is possible to decrease the size of the first reflection surface 101 and the size of the second reflection surface 102. For example, the size (the horizontal width) of the first reflection surface 101 can be set to 4 mm and the size (the horizontal width) of the second reflection surface 102 can be set to 13 mm.

### Fifth Embodiment

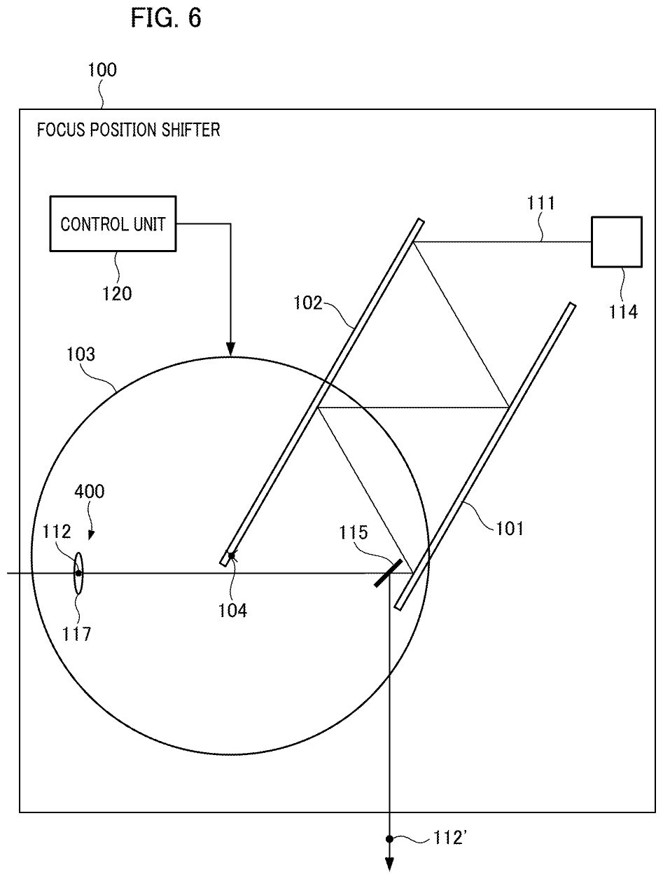

FIG. 6 is a diagram illustrating a fifth embodiment which is a specific example of the optical apparatus in FIG. 1.

The fifth embodiment is an example in which light from the non-collimating optical system 400 is reflected by the first reflection surface 101 and the second reflection surface 102 a plurality of times.

In this example, by changing a configuration in which a distance between the first reflection surface 101 and the second reflection surface 102 is close or an area where the first reflection surface 101 faces the second reflection surface 102 is increased, it is possible to increase the number of times the light is reflected between the first reflection surface 101 and the second reflection surface 102.

For example, in the drawing, light is reflected twice by the first reflection surface 101 and the second reflection surface 102 along the forward path to the third reflection surface and is reflected twice from the first reflection surface 101 and the second reflection surface 102 along the return path from the third reflection surface 114. In the above-described first to fourth embodiments, the number of times the light is reflected by the first reflection surface 101 and the second reflection surface 102 along the forward path and the return path is only once. That is, according to this example, the optical path length can be increased about two times, compared to the above-described first to fourth embodiments.

This means that the range of the rotational angle θ of the stage 103 can be further reduced in this example than in the above-described first to fourth embodiments when the range of the change in the optical path length is constant. That is, in this example, since a desired optical path length can be obtained in accordance with the small rotational angle θ, it is possible to contribute to the control of the focus position at a high speed and with high precision.

In this example, since the distance between the first reflection surface 101 and the second reflection surface 102 is narrow and the first reflection surface 101 and the second reflection surface 102 are disposed at positions close to the rotational shaft 104, a load on the motor can be reduced, thereby realizing a high-speed operation.

The number of times the light is reflected between the first reflection surface 101 and the second reflection surface 102 is not limited to 2, but may be 3 or more.

### Sixth Embodiment

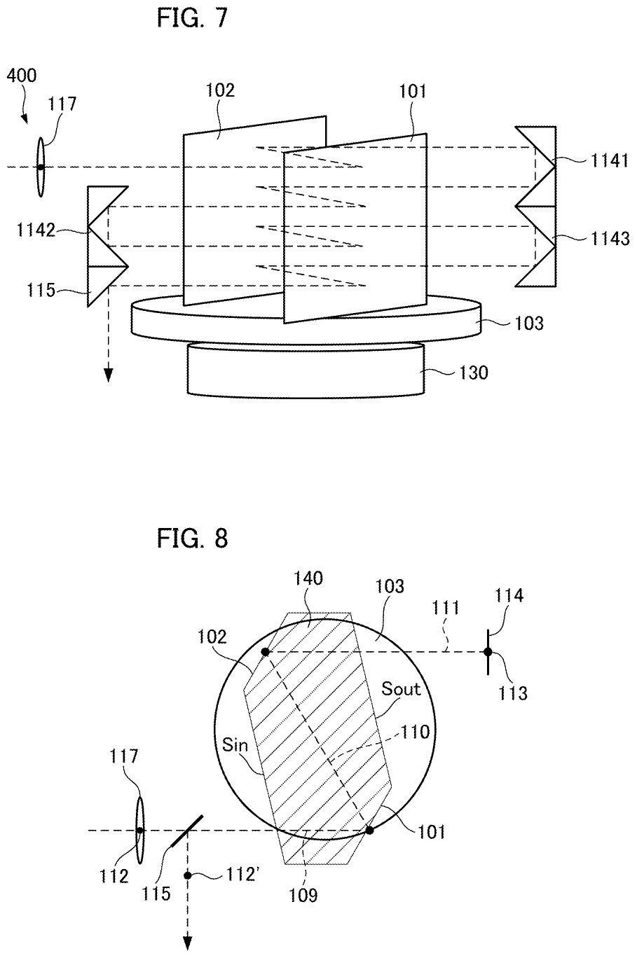

FIG. 7 is a diagram illustrating a sixth embodiment which is a specific example of the optical apparatus in FIG. 1.

The sixth embodiment is an example in which light reciprocates a plurality of times along the forward path and the return path in the above-described first to fourth embodiments. Therefore, the optical apparatus according to this example includes a plurality of return-back reflection surfaces that return back light.

For example, in this example, first, second, and third return-back reflection surfaces 1141, 1142, and 1143 are included. The first return-back reflection surface 1141 is equivalent to the third reflection surface 114 in the above-described first to fifth embodiments. The second return-back reflection surface 1142 functions as a fifth reflection surface that returns the light returned back by the first return-back reflection surface 1141 and reflected by the first reflection surface 101, to the first reflection surface 101. The third return-back reflection surface 1143 functions as a sixth reflection surface that returns light returned back by the second return-back reflection surface 1142 and reflected by the second reflection surface 102, to the second reflection surface 102.

Each of the first, second, and third return-back reflection surfaces 1141, 1142, and 1143 is a mirror that has two perpendicular reflection surfaces. Thus, optical paths of incident light incident on each return-back reflection surface and reflected light reflected from each return-back reflection surface can be displaced. That is, the light can reciprocate a plurality of times between the first, second, and third return-back reflection surfaces 1141, 1142, and 1143.

In this example, a direction in which the light is displaced by the first, second, and third return-back reflection surfaces 1141, 1142, and 1143 is a direction perpendicular to the upper surface of the stage 103, but the present invention is not limited thereto. For example, the direction in which the light is displaced by the first, second, and third return-back reflection surfaces 1141, 1142, and 1143 may be a direction parallel to the upper surface of the stage 103.

In the foregoing configuration, a motor 130 such as a galvano-motor rotationally drives the stage 103 to set the rotational angle θ of the stage 103. Thereafter, light from the non-collimating optical system 400 reciprocates twice between the first, second, and third return-back reflection surfaces 1141, 1142, and 1143 and is subsequently extracted by the fourth reflection surface 115.

According to this example, the optical path length can be increased as in the fifth embodiment. Accordingly, a desired optical path length can be obtained in accordance with the small rotational angle θ. As a result, it is possible to control the focus position at a high speed and with high precision. The distance between the first reflection surface 101 and the second reflection surface 102 is narrow and the first reflection surface 101 and the second reflection surface 102 are disposed at positions close to the rotational shaft 104, and thus a load on the motor can be reduced, thereby realizing a high-speed operation.

The number of times light reciprocates between the plurality of return-back reflection surfaces is not limited to 2, but may be 3 or more.

### Seventh Embodiment

FIG. 8 is a diagram illustrating a seventh embodiment which is a specific example of the optical apparatus in FIG. 1.

The seventh embodiment relates to a configuration of the first and second reflection surfaces 101 and 102. In the above-described first to sixth embodiments, the first and second reflection surfaces 101 and 102 are, for example, the mutually independent mirrors. However, the first and second reflection surfaces 101 and 102 are not limited thereto and may be inner surfaces of a predetermined member.

For example, as illustrated in the drawing, the first and second reflection surfaces 101 and 102 may be crystal surfaces of one crystal (for example, a glass material). That is, a crystal 140 has the first and second reflection surfaces 101 and 102 therein. The crystal 140 is fixed to the stage 103.

In this example, parallelism of the first and second reflection surfaces 101 and 102 can be improved through polishing work on the crystal 140. That is, when the first and second reflection surfaces 101 and 102 are independent mirrors and each mirror is fixed to the stage 103, parallelism of the first and second reflection surfaces 101 and 102 has to be adjusted, and thus the work may be complicated. Thus, when the crystal 140 is used, work for ensuring the parallelism of the first and second reflection surfaces 101 and 102 and work for mounting the first and second reflection surfaces 101 and 102 on the stage 103 can be separately performed.

Accordingly, according to this example, it is possible to efficiently perform work for assembling the optical apparatus.

When the crystal 140 is used as the first and second reflection surfaces 101 and 102, an end surface Sᵢₙ on which light is incident and an end surface Sₒᵤₜ from which the light is emitted are preferably coated to reduce reflection of the light.

The crystal 140 is preferably set so that angles formed between optical axis of light on the optical paths 109 and 111 and the end surfaces Sᵢₙ and Sₒᵤₜ are the so-called Brewster's angle. The Brewster's angle depends on a material of the crystal 140 and is, for example, about 60°. In this case, by setting about 60° as each of an angle formed between the optical axis of the light on the optical path 109 and the end surface Sᵢₙ and an angle formed between the optical axis of the light on the optical path 111 and the end surface Sₒᵤₜ, it is possible to reduce a reflection loss on the end surfaces Sᵢₙ and Sₒᵤₜ.

### Eighth Embodiment

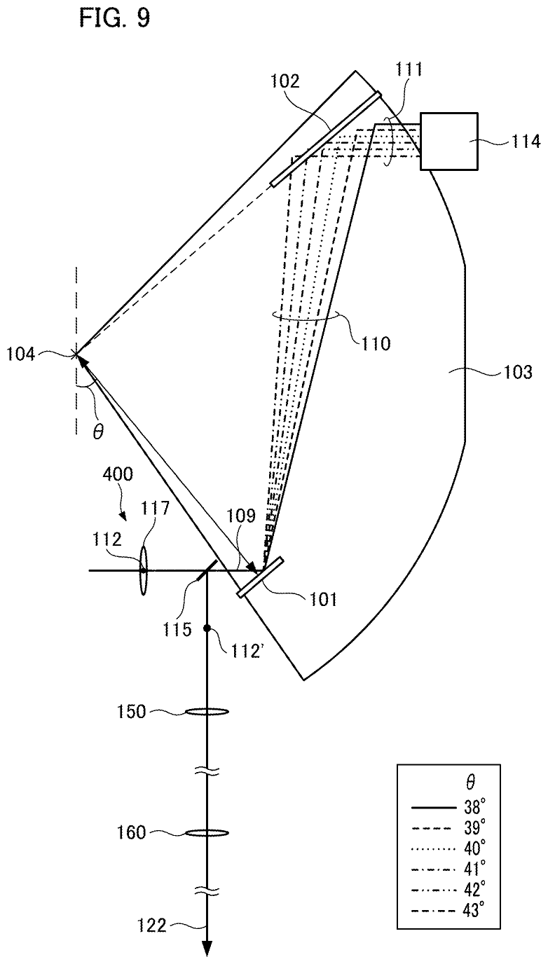

FIG. 9 is a diagram illustrating an eighth embodiment which is a specific example of the optical apparatus in FIG. 1.

The eighth embodiment is an example of a case in which spots of convergent light from the condensing lens 117 are formed during propagation of the light inside the focus position shifter 100 and the light is emitted as diffused light from the focus position shifter 100. In this case, the diffused light emitted from the focus position shifter 100 is changed into the convergent light by an optical system 400′ so that the spots of the light are bounded again.

The optical system 400′ is a convergent optical system that causes a beam diameter of light to be convergent in a propagation direction of the light. The optical system 400′ includes, for example, condensing lenses 150 and 160. Spots of the emitted light 122 extracted from the fourth reflection surface 115 are formed after the emitted light 122 passes through the condensing lenses 150 and 160.

Here, a is a distance from a spot position formed inside the focus position shifter 100 by the condensing lens 117 to the condensing lens 150 and b is a distance from the condensing lens 150 to a spot position of the light condensed by the condensing lens 150. In addition, f is a focal distance of the condensing lens 150. At this time, a>f is satisfied.

The following relation is established.

$$\frac{1}{a} + \frac{1}{b} = \frac{1}{f} \qquad ( 24 )$$

Accordingly, an optical path length is controlled using the focus position shifter 100, that is, the distance b can be controlled by controlling the distance a.

In this example, by providing the optical system 400′, it is possible to cause the focus position shifter 100 to control a focus position and set the focus position at a position relatively distant from the focus position shifter 100. Therefore, it is possible to improve the degree of freedom of the focus position in the optical axis direction and dispose a device such as a galvano-mirror controlling a direction of the emitted light 122 (the focus position in the direction perpendicular to the optical axis) inside the optical system 400′.

In the foregoing configuration, for example, collimated light (parallel light) is incident on the condensing lens 117. A focal distance of the condensing lens 117 is, for example, 50 mm. In this example, the length of the perpendicular line drawn from the rotational axis 104 to the first reflection surface 101 or the plane including the first reflection surface 101 is set to 20 mm. The length of the perpendicular line drawn from the rotational axis 104 to the second reflection surface 102 or the plane including the second reflection surface 102 is set to 0 mm. That is, the rotational shaft 104 is included in the second reflection surface 102 or the plane including the second reflection surface 102.

The rotational angle θ of the stage 103 is controlled within a range of 38° to 43°. FIG. 9 illustrates a change in the optical path at intervals of 1° so that the optical path is easily seen. The condensing lens 117 is disposed at a position of 5 mm in the x direction and −15 mm in the y direction from the rotational shaft 104. The third reflection surface 114 is disposed at a position of 25 mm in the x direction. In this case, an optical path length of the emitted light 122 reflected from the condensing lens 117 by the third reflection surface 114 and emitted from the focus position shifter 100 can be controlled within a range of about 89.3 mm to 94.6 mm.

The emitted light 122 extracted by the fourth reflection surface 115 is incident on the condensing lens 150 inside the optical system 400′. When a distance from the fourth reflection surface 114 to the condensing lens 150 is about 10.5 mm, an optical path length from the incidence point 112 to the emission point 112′ can be controlled within a range of 94.8 mm to 100.1 mm.

When a focal distance f of the condensing lens 150 is assumed to be 15 mm, a focus point on the emission side can be controlled within a range of 22.5 mm to 21.4 mm. A condensing lens 160 is disposed at a position of 50 mm from the condensing lens 150. In this case, when the focal distance of the condensing lens 160 is assumed to be 20 mm, a focus point is formed at a position of 73.3 mm to 66.7 mm from the condensing lens 160.

In this example, one condensing lens 117 is used in the non-collimating optical system 400 and two condensing lenses 150 and 160 are used in the convergent optical system 400′. Here, the number of lenses used in the optical apparatus in this example is not limited to 3. For example, the number of lenses can also be increased or decreased in accordance with a focus position (designed value). Optical design in which a focus position is controlled while condensing light with a desired numerical aperture NA may be realized. Further, a lens included in the non-collimating optical system 400 and the convergent optical system 400′ is not limited to a convex lens and may be a concave lens, a cylindrical lens, or the like.

### Ninth Embodiment

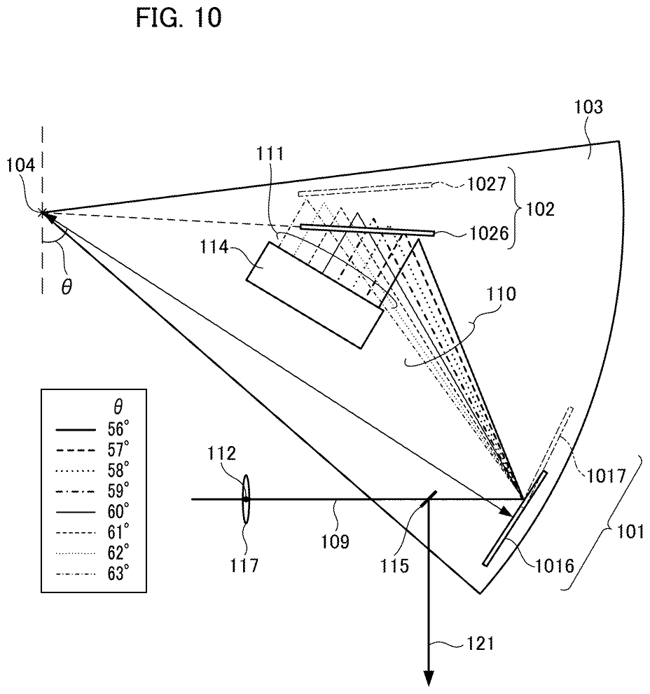

FIG. 10 is a diagram illustrating a ninth embodiment which is a specific example of the optical apparatus in FIG. 1.

The ninth embodiment is an example of a case in which the first reflection surface 101 and the second reflection surface 102 are nonparallel to each other. Here, although the first reflection surface 101 and the second reflection surface 102 are described as being nonparallel, it is necessary for the first reflection surface 101 and the second reflection surface 102 to face each other. That is, the light from the first reflection surface 101 can be reflected by the second reflection surface 102 in this disposition.

For example, an angle α formed between the first reflection surface 101 (1016 and 1017) and the second reflection surface 102 (1026 and 1027) is about 60°. The first reflection surface 1016 and the second reflection surface 1026 correspond to the case in which the rotational angle θ is 56°. The first reflection surface 1017 and the second reflection surface 1027 correspond to the case in which the rotational angle θ is 63°.

R1 is the length of the perpendicular line drawn from the rotational axis 104 to the first reflection surface 101 or the plane including the first reflection surface 101 and R2 is the length of the perpendicular line drawn from the rotational axis 104 to the second reflection surface 102 or the plane including the second reflection surface 102. In this case, the coordinates (x₀₁, y₀₁) of the intersection 105 and the coordinates (x₀₂, y₀₂) of the intersection 106 are expressed in Expressions (25) to (28) below.

$$\begin{matrix}{x}_{01} = {R}_{1} \times cos ( θ - \frac{π}{2} ) = {R}_{1} \times sin ( θ ) & ( 25 ) \\ {y}_{01} = {R}_{1} \times sin ( θ - \frac{π}{2} ) = - {R}_{1} \times cos ( θ ) & ( 26 ) \\ {x}_{02} = {R}_{2} \times cos ( θ + α + \frac{π}{2} ) = - {R}_{2} \times sin ( θ + α ) & ( 27 ) \\ {y}_{02} = {R}_{2} \times sin ( θ + α + \frac{π}{2} ) = {R}_{2} \times cos ( θ + α ) & ( 28 )\end{matrix}$$

When (x₁, y₁) are coordinates on the first reflection surface 101 and (x₂, y₂) are coordinates on the second reflection surface 102, the coordinates are described in Expressions (29) and (30) below.

y₁−y₀₁=(tan θ)×(x₁−x₀₁) (29)

y₂−y₀₂=(tan(θ+α))×(x₂−x₀₂) (30)

Here, (xₘ₁, yₘ₁) are a point at which light from the non-collimating optical system 400 is reflected by the first reflection surface 101 and (xₘ₂, yₘ₂) are a point at which light is reflected by the second reflection surface 102. In addition, y_{B1} is the y coordinate on the optical path 109 and (x_{BR}, y_{BR}) are coordinates on the optical path 110 between the first reflection surface 101 and the second reflection surface 102. In this case, coordinates on the optical path 110 between the first reflection surface 101 and the second reflection surface 102 can be described in Expression (31).

y_{BR}−yₘ₁=tan(2θ)×(x_{BR}−xₘ₁) (31)

In addition, when (xₒ, yₒ) are coordinates on the optical path 111 between the second reflection surface 102 and the third reflection surface 114, coordinates on the optical path 111 can be described in Expression (32).

y_{O}−yₘ₂=tan(2α)×(x_{O}−xₘ₂) (32)

As understood from the above, a change amount of the optical path length depends not on the distances R1 and R2 between the rotational shaft 104 and the first and second reflection surfaces 101 and 102 but on the distance (R1+R2) between the first and second reflection surfaces 101 and 102. That is, when the distance between the first and second reflection surfaces 101 and 102 is shortened, the optical path length can be decreased. In contrast, when the distance between the first and second reflection surfaces 101 and 102 is lengthened, the optical path length can be increased.

In the foregoing configuration, for example, collimated light (parallel light) is incident on the condensing lens 117 of a focal distance 100 mm. The rotational angle θ of the stage 103 is controlled within a range of 56° to 63°. The first reflection surface 101 is disposed at a position of 50 mm (R1=50) from the rotational shaft 104 and the second reflection surface 102 is disposed at a position of 0 mm (R2=0) from the rotational shaft 104. The second reflection surface 102 is inclined by α=−60° with respect to the first reflection surface 101.

The condensing lens 117 is disposed at a position of 30 mm in the x direction and −25.7 mm in the y direction from the rotational shaft 104. The third reflection surface 114 has layout in which light is reflected at a position of 30 mm in the x direction from the rotational shaft 104 when the rotational angle θ is 56°. The third reflection surface 114 is inclined by 2α(=120°) with respect to the y axis so that an optical path of reflected light overlaps an optical path of incident light.

The third reflection surface 114 may have layout so that the optical path of reflected light does not overlap the optical path of incident light. For example, the third reflection surface 114 may include two mutually perpendicular reflection surfaces so that the optical path of reflected light is slightly shifted from the optical path of incident light in the z direction (which is a direction perpendicular to the upper surface of the stage 103). The third reflection surface 114 may be slightly inclined in the z direction so that the optical path of reflected light does not overlap the optical path of incident light.

In the foregoing configuration, the optical path length can be changed within a range of 45.2 mm to 51.4 mm. That is, a change amount of 6.2 mm can be realized as the optical path length by controlling the rotational angle θ of the stage 103. When the fourth reflection surface 115 is assumed to be disposed at a position distant by 5 mm from immediately below an incident light end, the focus position can be controlled within a range of 59.8 mm to 53.6 mm from the fourth reflection surface 115.

When the first reflection surface 101 and the second reflection surface 102 are parallel to each other, the optical path length can be controlled within a range of, for example, 82.9 mm to 89.1. That is, in this case, a change amount of the optical path length is 6.2 mm and is constant in this example. However, when the first reflection surface 101 and the second reflection surface 102 are parallel to each other, an optical path length necessary to realize the change amount is longer by about 90 mm than in this example. Accordingly, contrivance such as an increase in a focal distance of the condensing lens is necessary.

In this example, however, since a predetermined change amount can be obtained with a short optical path length, the focus position in the optical axis direction can be controlled without contrivance of an increase in the focal distance of the condensing lens.

In this example, the layout of the second reflection surface 102 may be decided so that reflection of the light by the second reflection surface 102 occurs nearer to the rotational shaft 104. In this case, a load on the galvano-motor is reduced, and thus the focus position can be controlled at a high speed.

### Tenth Embodiment

Next, a technology for controlling a focus position in a direction perpendicular to an optical axis using a focus position shifter according to a tenth embodiment will be described.

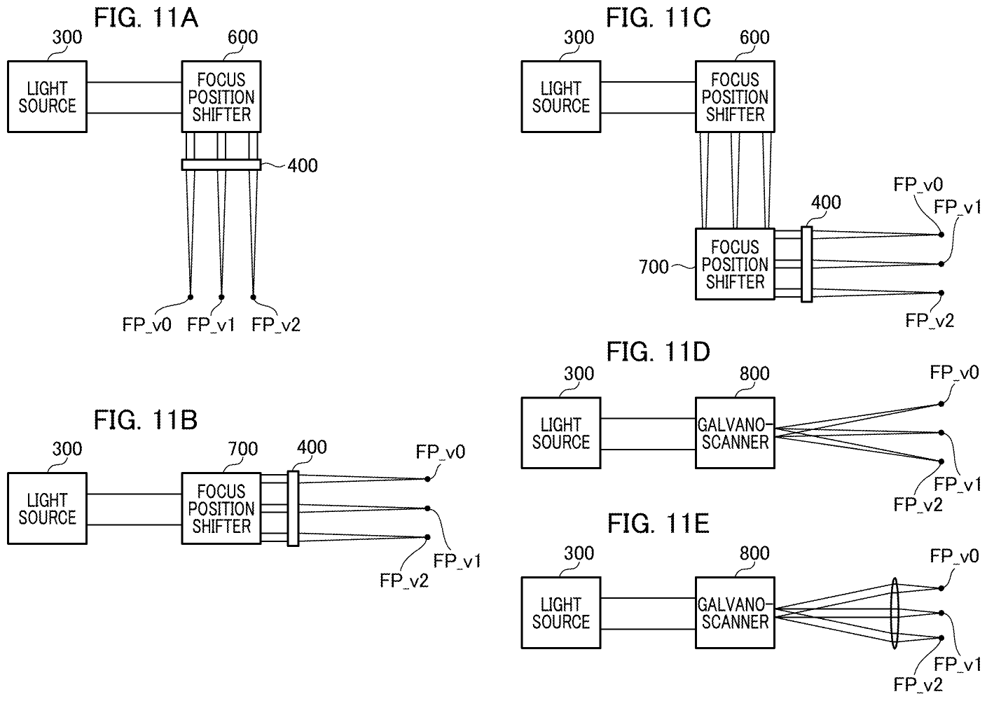

FIGS. 11A to 11E are diagrams illustrating an example of an optical apparatus including the focus position shifter according to the tenth embodiment.

FIG. 11A illustrates an example in which a direction of an optical axis of light incident on the focus position shifter 600 is different from a direction of an optical axis of light emitted from the focus position shifter 600. Here, the different directions mean that the optical axis of the light emitted from the focus position shifter 600 has an inclination (for example, an inclination of 90°) equal to or greater than 45° and equal to or less than 135° with respect to the optical axis of the light incident on the focus position shifter 600.

FIG. 11B illustrates an example in which the direction of an optical axis of light incident on the focus position shifter 700 is the same as that of an optical axis of light emitted from the focus position shifter 700. Here, the same direction means that the optical axis of the light emitted from the focus position shifter 700 is within a range equal to or greater than 0° (parallel) and less than 45° with respect to the optical axis of the light incident on the focus position shifter 700.

FIG. 11C illustrates a combination example of the focus position shifter 600 in FIG. 11A and the focus position shifter 700 in FIG. 11B.

FIGS. 11D and 11E illustrate comparative examples. In the comparative examples, focus positions FP_h0, FP_h1, and FP_h2 in a direction perpendicular to the optical axis are controlled using a galvano-scanner 800 that includes a so-called fθ lens. However, an optical axis of light emitted from the galvano-scanner 800 depends on the focus positions FP_h0, FP_h1, and FP_h2 and are nonparallel to each other. Accordingly, a beam diameter at the focus positions FP_h0, FP_h1, and FP_h2 is changed in accordance with the focus position.

The focus position shifters 600 and 700 illustrated in FIGS. 11A and 11B change emission positions of light from the focus position shifters 600 and 700 in accordance with the focus positions FP_h0, FP_h1, and FP_h2. Thus, the optical axes of the light emitted from the focus position shifters 600 and 700 do not depend on the focus positions FP_h0, FP_h1, and FP_h2 and are parallel to each other. Accordingly, the beam diameter at the focus positions FP_h0, FP_h1, and FP_h2 is not changed and the focus position in the direction perpendicular to the optical axes can be controlled.

For example, the light from the light source 300 is incident on the focus position shifters 600 and 700 in a state in which light from the light source 300 is, for example, collimated light (parallel light). The focus position shifters 600 and 700 perform control such that an optical path of light emitted from each focus position shifter is shifted in a direction perpendicular to the optical path. Then, the light emitted from the focus position shifters 600 and 700 is changed into convergent light by the non-collimating optical system 400.

Here, in the embodiment, the non-collimating optical system 400 that generates the convergent light to form a focus point is disposed on the rear stage of the focus position shifters 600 and 700. This is because the focus position in the optical axis direction may simultaneously be changed due to a change in the optical path length when the focus position (emission position) is controlled in the direction perpendicular to the optical axis using the non-collimated light.

That is, the embodiment has a purpose of independently controlling a focus position (emission position) in the direction perpendicular to the optical axis of the light. Accordingly, it is preferable that collimated light be incident on the focus position shifters 600 and 700 and light emitted from the focus position shifters 600 and 700 be changed into convergent light in the non-collimating optical system 400.

A case in which it is preferable to simultaneously perform control of the focus position in the optical axis direction of light and control of the focus position in the direction perpendicular to the optical axis of the light using one of the focus position shifters 600 and 700 is exceptional.

The light source 300 is, for example, a laser oscillator and light from the light source 300 is, for example, a laser beam.

The optical axis of the light emitted from the focus position shifters 600 and 700 does not depend on the focus positions FP_h0, FP_h1, and FP_h2 and are parallel to each other. This is because, as will be described in the following principle, the focus position in the direction perpendicular to the optical axis is not controlled by the fθ lens, but is controlled through control of rotational angles of the first and second reflection surfaces which face each other and can rotate about the rotational shaft.

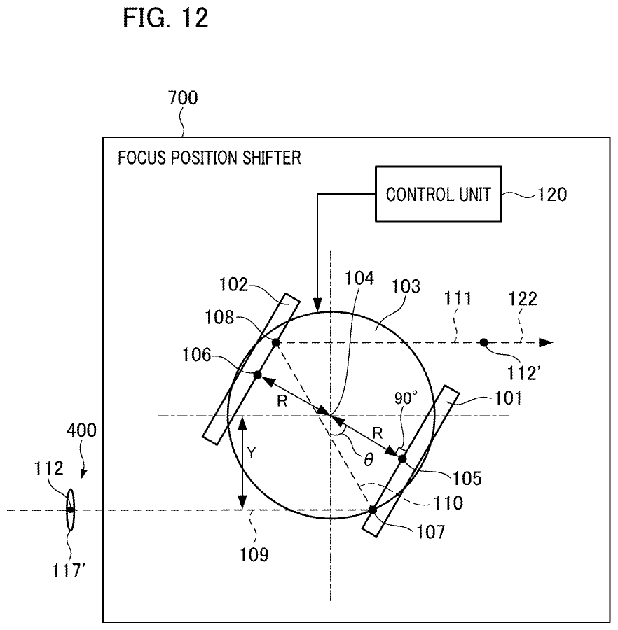

FIG. 12 is a diagram illustrating a principle of control of a focus position in a direction perpendicular to an optical axis in the tenth embodiment.

The focus position in the direction perpendicular to the optical axis is controlled by the focus position shifter 700. The focus position shifter 700 controls the focus position in the direction perpendicular to the optical axis of light emitted from the focus position shifter 700 by shifting the optical path of light incident from the non-collimating optical system 400.

Therefore, the focus position shifter 700 includes the first reflection surface 101, the second reflection surface 102 facing the first reflection surface 101, and the control unit 120.

The first reflection surface 101 and the second reflection surface 102 are, for example, mirrors. In this example, to facilitate the description, it is assumed that the first reflection surface 101 and the second reflection surface 102 are parallel to each other. However, the first reflection surface 101 and the second reflection surface 102 may not be parallel to each other as long as the first reflection surface 101 and the second reflection surface 102 face each other.

Here, the fact that the first reflection surface 101 and the second reflection surface 102 face each other means that the angle α between the first reflection surface 101 and the second reflection surface 102 is within the range equal to or greater than 0° (parallel) and less than 90°. This is because it is important for the second reflection surface 102 to be able to reflect light from the first reflection surface 101, as will be described below.

Both the first reflection surface 101 and the second reflection surface 102 can rotate about the rotational shaft 104. It is necessary for the first reflection surface 101 and the second reflection surface 102 to rotate about the rotational shaft 104 in a state in which a relative arrangement between the first reflection surface 101 and the second reflection surface 102 is maintained. Therefore, the focus position shifter 700 includes, for example, the stage 103 that can rotate about the rotational shaft 104. In this case, the first reflection surface 101 and the second reflection surface 102 are fixed to the stage 103. The control unit 120 shifts the optical path of the light incident on the non-collimating optical system 400 by changing a rotational angle of the stage 103 and controls the focus position in the direction perpendicular to the optical axis of the light emitted from the focus position shifter 100.

As will be described below, the rotational shaft 104 may be in a region between the first reflection surface 101 and the second reflection surface 102 or may be in a region other than the region between the first reflection surface 101 and the second reflection surface 102.

The first reflection surface 101 reflects the light from the non-collimating optical system 400. The light reflected by the first reflection surface 101 goes toward the second reflection surface 102 and is reflected by the second reflection surface 102. That is, the light from the non-collimating optical system 400 is output to the emission point 112′ via the optical paths 109, 110, and 111 in sequence.

When the focus position shifter 700 is used, for example, the control unit 120 can change an emission position of the light emitted from the focus position shifter 700 by controlling the rotational angle of the stage 103. Accordingly, it is possible to control the focus position in the direction perpendicular to the optical axis of the emitted light 122 emitted from the focus position shifter 700.

Shifting of the optical path inside the focus position shifter 700 will be described.

In the following description, a central point of a lens 117′ is the incidence point 112 of light, and (xᵢ, yᵢ) are the coordinates of the incidence point 112. In addition, (xₒ, yₒ) are the coordinates of the emission point 112′ at which the light from the second reflection surface 102 is emitted.

In addition, (x₀₁, y₀₁) are the coordinates of the intersection 105 between the first reflection surface 101 and the perpendicular line drawn from the rotational shaft 104 to the first reflection surface 101 and (x₀₂, y₀₂) are the coordinates of the intersection 106 between the second reflection surface 102 and the perpendicular line drawn from the rotational shaft 104 to the second reflection surface 102. The length R of the perpendicular line drawn from the rotational shaft 104 to the first reflection surface 101 is assumed to be the same as the length R of the perpendicular line drawn from the rotational shaft 104 to the second reflection surface 102. That is, an interval between the first reflection surface 101 and the second reflection surface 102 is assumed to be 2R.

When a perpendicular line is drawn from the rotational shaft 104 to the optical path (incidence optical axis) 109, the length of the perpendicular line is assumed to be Y. That is, light incident on the non-collimating optical system 400 is incident on the first reflection surface 101 to be offset by the distance Y from the rotational shaft 104. A state in which the first reflection surface 101 is parallel to the optical path (the incidence optical axis) 109 is defined as a rotational angle 0°. Here, at the rotational angle 0°, the first reflection surface 101 is assumed to be closer to the optical path (incidence optical axis) 109 than the second reflection surface 102.

The stage 103 is assumed to be rotated counterclockwise by the angle θ from the rotational angle 0° when the state of the rotational angle 0° is set as a reference. The rotational angle θ is controlled within a range of, for example, 0° to 90°. Accordingly, a motor that rotates the stage 103 is preferably a galvano-motor that can rotate the stage 103 counterclockwise or clockwise. Here, the motor that rotates the stage 103 may be a rotational motor that can rotate the stage 103 only unidirectionally (for example, counterclockwise). In this case, when the rotational angle θ is set to be small, the rotational angle θ may be controlled again from the state of the rotational angle 0° by rotating the stage 103 once.

On the above premise, first, the coordinates (x₀₁, y₀₁) of the intersection 105 and the coordinates (x₀₂, y₀₂) of the intersection 106 are expressed in Expressions (33) to (36) below.

$$\begin{matrix}{x}_{01} = R \times cos ( θ - \frac{π}{2} ) = R \times sin ( θ ) & ( 33 ) \\ {y}_{01} = R \times sin ( θ - \frac{π}{2} ) = - R \times cos ( θ ) & ( 34 ) \\ {x}_{02} = R \times cos ( θ + \frac{π}{2} ) = - R \times sin ( θ ) & ( 35 ) \\ {y}_{02} = R \times sin ( θ + \frac{π}{2} ) = R \times cos ( θ ) & ( 36 )\end{matrix}$$

Next, when (x₁, y₁) are coordinates on the first reflection surface 10 and (x₂, y₂) are coordinates on the second reflection surface 102, relations shown in Expressions (37) and (38) below can be obtained.

y₁−y₀₁=(tan θ)×(x₁−x₀₁) (37)

y₂y₀₂=(tan θ)×(x₂−x₀₂) (38)

Next, (xₘ₁, yₘ₁) are coordinates of a point 107 on the first reflection surface 101 that reflects light from the non-collimating optical system 400 and (xₘ₂, yₘ₂) are coordinates of a point 108 on the second reflection surface 102 that reflects light from the first reflection surface 101. It is assumed that y_{B1} is the y coordinate on the optical path 109 between the non-collimating optical system 400 and the first reflection surface 101 and (x_{BR}, y_{BR}) are coordinates on the optical path 110 between the first reflection surface 101 and the second reflection surface 102. In this case, coordinates on the optical path 110 between the first reflection surface 101 and the second reflection surface 102 can be described in Expression (39) below.

y_{BR}−yₘ₁=tan(2θ)×(x_{BR}−xₘ₁) (39)

Next, y_{BO} is the y coordinate on the optical path 111 of light reflected by the second reflection surface 102. In this case, the coordinates (xₘ₁, yₘ₁) of the reflection point 107 and the coordinates (xₘ₂, yₘ₂) of the reflection point 108 are expressed in Expressions (40) to (43) below.

$$\begin{matrix}{x}_{m 1} = \frac{Y}{tan θ} + \frac{R}{sin θ} & ( 40 ) \\ {y}_{m 1} = Y & ( 41 ) \\ {x}_{m 2} = \frac{Y}{tan θ} + 2 R \times \frac{1}{sin ( θ )} \times \frac{tan ( 2 θ )}{tan ( 2 θ ) - tan ( θ )} - \frac{R}{sin ( θ )} & ( 42 ) \\ {y}_{m 2} = Y + 2 R \times \frac{1}{sin ( θ )} \times \frac{tan ( 2 θ ) \times tan ( θ )}{tan ( 2 θ ) - tan ( θ )} & ( 43 )\end{matrix}$$

Here, since the first reflection surface 101 and the second reflection surface 102 are parallel to each other, light from the second reflection surface 102 propagates along the optical path 111 parallel to the optical path 109, that is, the optical path on y=yₘ₂ and is output to the emission point 11T. As expressed in Expression (43), it can be understood that the y coordinate is changed by changing the rotational angle θ of the stage 103. By changing the distance R from the rotational shaft 104 to the first reflection point 101 and the distance R from the rotational shaft 104 to the second reflection point 102, it is possible to increase the shift amount.

Accordingly, according to the foregoing principle, it is possible to control an emission position of the light emitted from the focus position shifter 700 in accordance with the rotational angle θ and control the focus position in the direction perpendicular to the optical axis of the light.

In the foregoing description, it is assumed that the first reflection surface 101 and the second reflection surface 102 are parallel to each other, but the above-described principle can be applied even when both the first reflection surface 101 and the second reflection surface 102 are nonparallel to each other.

For example, when it is assumed that the first reflection surface 101 deviates from the second reflection surface 102 by an angle α, an optical axis of light along the optical path 111 deviates from the optical axis of light along the optical path 109 by (2×α). However, since the optical axis of light along the optical path 111 does not depend on the rotational angle θ, the light from the second reflection surface 102 is translating despite a change in the rotational angle θ. That is, even when the rotational angle θ is changed, the relation in which the optical axis of light along the optical path 111 deviates from the optical axis of light along the optical path 109 by (2×α) is constant.

This means that the above-described principle can be applied even when the first reflection surface 101 and the second reflection surface 102 are nonparallel to each other. In other words, this means that the parallelism may not be set precisely even when it is assumed that the first reflection surface 101 and the second reflection surface 102 are parallel to each other. An optical system installed after the emission point 112′ can compensate for a variation in the parallelism in accordance with reflection positions of the first reflection surface 101 and the second reflection surface 102.

### Eleventh Embodiment

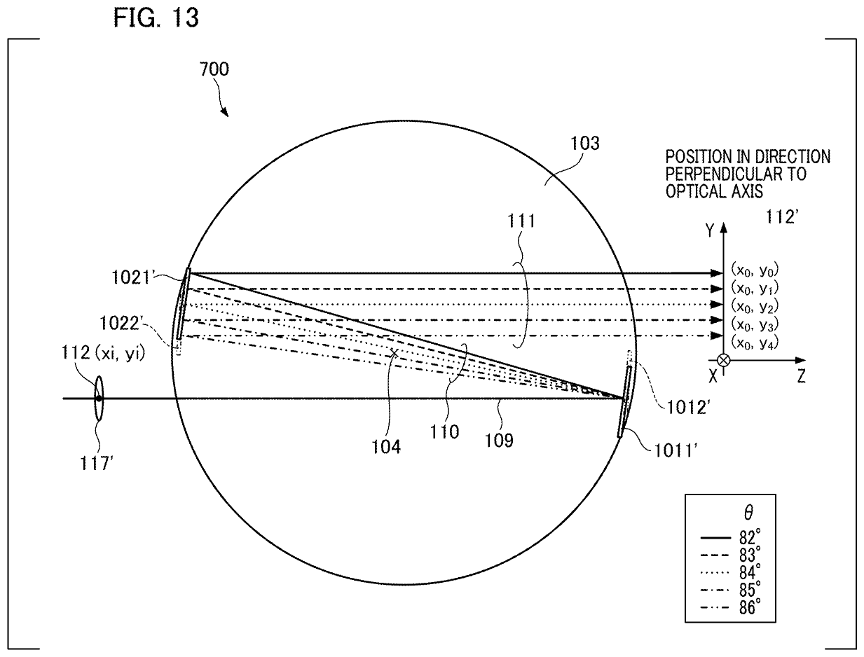

FIG. 13 is a diagram illustrating an eleventh embodiment which is a specific example of the optical apparatus in FIGS. 11A to 11E.

This example is an example of an optical path when the rotational angle θ of the stage 103 is changed in units of 1° within a range of 82° to 86°.

First reflection surfaces 1011′ . . . and 1012′ are disposed at positions of 25 mm from the rotational shaft 104 (coordinates (0, 0)) and the second reflection surfaces 1021′ . . . and 1022′ are also disposed at positions of 25 mm from the rotational shaft 104. The first reflection surface 1011′ and the second reflection surface 1021′ correspond to the case of the rotational angle θ of 82° and are disposed to be parallel to each other. The first reflection surface 1012′ and the second reflection surface 1022′ correspond to the case of the rotational angle θ of 86° and are disposed to be parallel to each other.

The sizes of the first reflection surfaces 1011′ . . . and 1012′ and the sizes of the second reflection surfaces 1021′ . . . and 1022′ are the same and are, for example, 8 mm. In this example, the sizes of the first reflection surfaces 1011′ . . . and 1012′ and the sizes of the second reflection surfaces 1021′ . . . and 1022′ are assumed to be sizes (horizontal widths) in a direction parallel to the upper surface of the stage 103. Here, the optical axis direction of light along the optical path 109 is referred to as an x axis and a direction perpendicular thereto is referred to as a y axis. The condensing lens 117′ is disposed at a position of −5 mm in the y direction (the lower side in the drawing) from the rotational shaft 104.

The collimated light is incident on the lens 117′ from the light source 300 and a focal distance of the condensing lens 117′ is 200 mm. The stage 103 is driven by the galvano-motor and the rotational angle θ is controlled within a range of 82° to 86°. A rotational speed of the stage 103 by the galvano-motor can be set to about 1 revolution per second (1 Hz=1 rps).

Under the foregoing conditions, the emission position of light from the focus position shifter 700, that is, the y coordinate of the emission point 112′, is changed within a range from y0 (=8.92 mm) to y4 (=3.72 mm) Here, y0 is an emission position when the rotational angle θ is 82°, and y4 is an emission position when the rotational angle θ is 86°. This means that the focus position shifter 700 in this example can control the focus point (the y coordinate) in the direction perpendicular to the optical axis within a range from 8.92 mm to 3.72 mm. Further, the optical path (optical axis) 111 of the light emitted from the focus position shifter 700 in this example does not depend on the rotational angle θ and is parallel. This means that the beam diameter at the focus point is not changed at each emission position.

According to this example, a speed of beam shifting is 5 mm/(4/360)=450 mm/ms in a range of the rotational angle θ from 82° to 86°. That is, according to this example, it is possible to control the focus position at a high speed and with high precision.

In a comparison example, however, the number of times light is reflected is 6 in a ring shifter disclosed in Patent Literature 1. In the focus position shifter 700 according to this example, the number of times light is reflected is 2. This means that the focus position can be controlled in a state in which the focus position shifter 700 according to this example sufficiently suppresses an optical loss on the reflection surface.

In this example, the stage 103 is a disc, but may be a part of a disc, a rod-like shape, or any other shape in view of a reduction in weight or the like. Here, in any shape, it is necessary to realize a structure in which the rotational shaft 104 is physically connected to the first reflection surfaces 1011′ . . . and 1012′ and the second reflection surfaces 1021′ . . . , and 1022′.

### Twelfth Embodiment

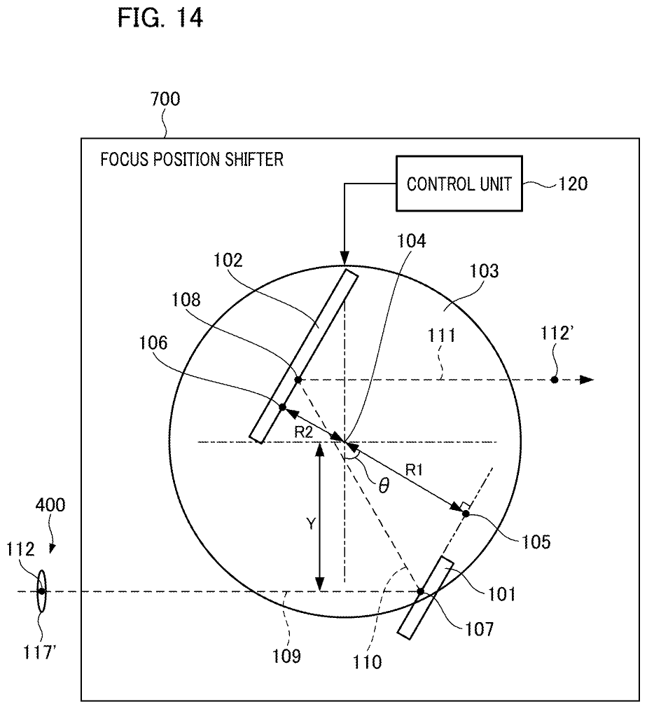

FIG. 14 is a diagram illustrating a twelfth embodiment which is a specific example of the optical apparatus in FIGS. 11A to 11E.

As described above, the size of the first reflection surface 101 may not be the same as the size of the second reflection surface 102. Accordingly, in this example, an example in which the size of the first reflection surface 101 is set to be smaller than the size of the second reflection surface 102 and, for example, the weight of the stage 103 driven by a galvano-motor is reduced will be described.

In this case, since a load on the galvano-motor is reduced, the stage 103 can be rotated at a high speed. This means that the focus position shifter 700 can control a focus position at a high speed and with high precision.

When the coordinate xₘ₁ indicated in Expression (44) is differentiated with respect to the rotational angle θ, the following expression is obtained.

$$\frac{{dx}_{m 1}}{d θ} = - \frac{1}{{cos}^{2} θ} \cdot ( Y + R cos θ ) \qquad ( 44 )$$

When Expression (44) is 0 at a central angle θ₀ of the controllable rotational angle θ, a displacement of xₘ₁ is the smallest. Accordingly, a relational expression indicated in Expression (45) can be obtained.

$$- \frac{1}{{cos}^{2} θ} \cdot ( Y + R cos θ ) = 0 \\ ⇔ cos θ = \frac{Y}{R} \qquad ( 45 )$$

Accordingly, when θ=θ₀, the coordinates (x₀₁, y₀₁) of the intersection 105 of the perpendicular line drawn from the rotational shaft 104 to the plane including the first reflection surface 101 and the plane are matched with coordinates (xₘ₁, yₘ₁) of a point 107 at which incident light is reflected from the first reflection surface 101. In this case, it is not necessary to increase the size of the first reflection surface 101 to cover displacement of xₘ₁. That is, by causing the size of the first reflection surface 101 to be smaller than the size of the second reflection surface 102, it is possible to reduce the weight of the stage 103. Since the coordinates (x₀₁, y₀₁) of the intersection 105 are matched with coordinates (xₘ₁, yₘ₁) of the reflection point 107 at θ=θ₀, the center of gravity on the stage 103 is easily stabilized, which also contributes to high-speed control of a focus position.

The configuration of the optical apparatus in this example is basically the same as the configuration of the tenth embodiment in FIG. 12. Here, the condensing lens 117 is disposed at a position of −2.13 mm in the y direction from the rotational shaft 104 so that Expression (44) becomes 0 at θ₀=84°. As a result, in the direction parallel to the upper surface of the stage 103, the size (horizontal width) of the first reflection surface 101 can be set to 2 mm and the size of the second reflection surface 102 can be set to 8 mm.

In this example, a length R1 of the perpendicular line drawn from the rotational shaft 104 to a plane including the first reflection surface 101 is different from a length R2 of the perpendicular line drawn from the rotational shaft 104 to the second reflection surface 102. In this case, the coordinates (x₀₁, y₀₁) of the intersection 105 and the coordinates (x₀₂, y₀₂) of the intersection 106 are expressed in Expressions (46) to (49) below.

$$\begin{matrix}{x}_{01} = {R}_{1} \times cos ( θ - \frac{π}{2} ) = {R}_{1} \times sin ( θ ) & ( 46 ) \\ {y}_{01} = {R}_{1} \times sin ( θ - \frac{π}{2} ) = - {R}_{1} \times cos ( θ ) & ( 47 ) \\ {x}_{02} = {R}_{2} \times cos ( θ + \frac{π}{2} ) = - {R}_{2} \times sin ( θ ) & ( 48 ) \\ {y}_{02} = {R}_{2} \times sin ( θ + \frac{π}{2} ) = {R}_{2} \times cos ( θ ) & ( 49 )\end{matrix}$$

In this case, the emission position, that is, the y coordinate (yₘ₂) of the emission point 112′, is as follows.

$${y}_{m 2} = Y + ( {R}_{1} + {R}_{2} ) \times \frac{1}{sin ( θ )} \times \frac{tan ( 2 θ ) \times tan ( θ )}{tan ( 2 θ ) - tan ( θ )} \qquad ( 50 )$$

When Expression (43) is compared to Expression (50), it can be understood that a change in the emission position does not depend on a distance from the rotational shaft 104, but depends on a distance (2R or R1+R2) between the first reflection surface 101 and the second reflection surface 102. In this example, as described above, the size of the second reflection surface 102 is greater than the size of the first reflection surface 101. Accordingly, in this example, the second reflection surface 102 is disposed at a position closer to the rotational shaft 104 than the first reflection surface 101.

As described above, according to the twelfth embodiment, a load on the galvano-motor is reduced. Therefore, the stage 103 can be rotated at a high speed and the focus position shifter 100 controls a focus position at a high speed and with high precision.

### Thirteenth Embodiment

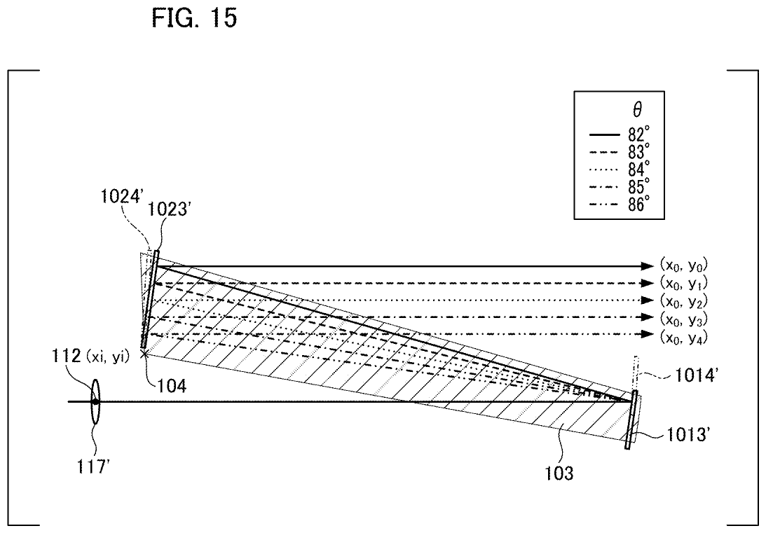

FIG. 15 is a diagram illustrating a thirteenth embodiment which is a specific example of the optical apparatus in FIGS. 11A to 11E.

The thirteenth embodiment is an example in which the first reflection surface 101 and the second reflection surface 102 are not disposed to be point-symmetric to the rotational shaft 104.

In this example, the length of a perpendicular line drawn from the rotational shaft 104 to the first reflection surface 101 or a plane including the first reflection surface 101 is set to 50 mm. The length of a perpendicular line drawn from the rotational shaft 104 to the second reflection surface 102 or a plane including the second reflection surface 102 is set to 0 mm. That is, the rotational shaft 104 is included in the second reflection surface 102 or the plane including the second reflection surface 102. The condensing lens 117′ is disposed at a position of −25 mm in they direction from the rotational shaft 104. Further, the size (horizontal width) of the first reflection surface 101 is set to 6 mm and the size (horizontal width) of the second reflection surface 102 is set to 10 mm.

The control unit 120 causes the galvano-motor to rotationally drive the stage 103. The control unit 120 controls a rotational angle of the stage 103 within a range of 82° to 86°. A rotational speed of the stage 103 by the galvano-motor is set to, for example, about 1 revolution per second (1 Hz=1 rps).

Under the foregoing conditions, the emission position of light from the focus position shifter 700, that is, the y coordinate of the emission point 112′, is changed within a range from y0 (=8.92 mm) to y4 (=3.72 mm). This means that the focus position shifter 700 in this example can control the focus point (the y coordinate) in the direction perpendicular to the optical axis within a range from 8.92 mm to 3.72 mm. Further, the optical path (optical axis) 111 of the light emitted from the focus position shifter 700 in this example does not depend on the rotational angle θ and is parallel. This means that the beam diameter at each focus point is not changed at each emission position.

According to this example, a speed of beam shifting is 5 mm/(4/360)=450 mm/ms in the range of the rotational angle θ from 82° to 86°. That is, according to this example, it is possible to control the focus position at a high speed and with high precision.

### Fourteenth Embodiment

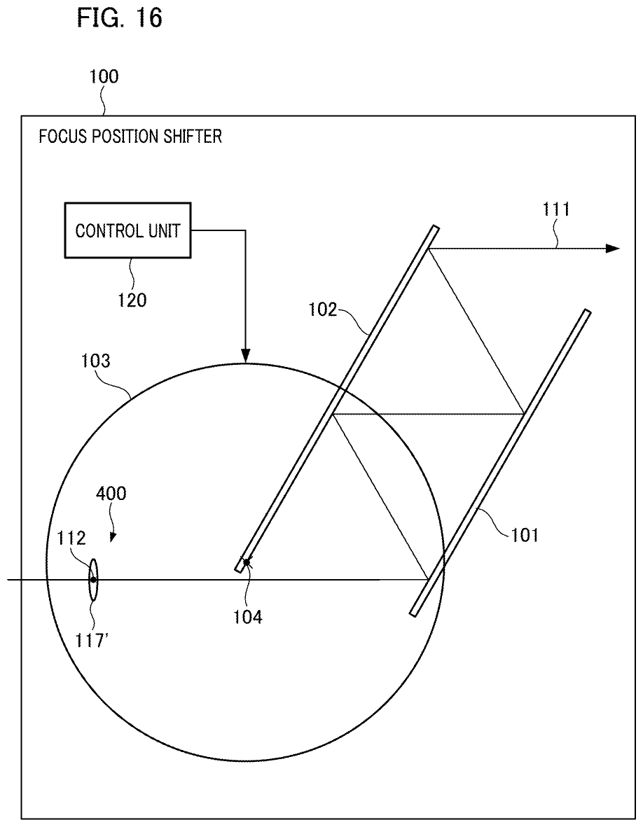

FIG. 16 is a diagram illustrating a fourteenth embodiment which is a specific example of the optical apparatus in FIGS. 11A to 11E.

The fourteenth embodiment is an example in which light from the non-collimating optical system 400 is reflected by the first reflection surface 101 and the second reflection surface 102 a plurality of times.

In this example, by changing a configuration in which a distance between the first reflection surface 101 and the second reflection surface 102 is close or an area where the first reflection surface 101 faces the second reflection surface 102 is increased, it is possible to increase the number of times the light is reflected between the first reflection surface 101 and the second reflection surface 102.

For example, in the drawing, light is reflected twice by the first reflection surface 101 and the second reflection surface 102. In the above-described first to thirteenth embodiments, the number of times the light is reflected by the first reflection surface 101 and the second reflection surface 102 is only once. That is, according to this example, the shift amount of the emission position can be increased by nearly doubled, compared to the above-described first to thirteenth embodiments.

This means that the range of the rotational angle θ of the stage 103 can be further reduced in this example than in the above-described first to thirteenth embodiments when the shift amount of the emission position is constant. That is, in this example, since emission position can be shifted by only a desired shift amount in accordance with the small rotational angle θ, it is possible to contribute to the control of the focus position at a high speed and with high precision.

In this example, since the distance between the first reflection surface 101 and the second reflection surface 102 is narrow and the first reflection surface 101 and the second reflection surface 102 are disposed at positions close to the rotational shaft 104, a load on the motor can be reduced, thereby realizing a high-speed operation.

The number of times the light is reflected between the first reflection surface 101 and the second reflection surface 102 is not limited to 2, but may be 3 or more.

### Fifteenth Embodiment

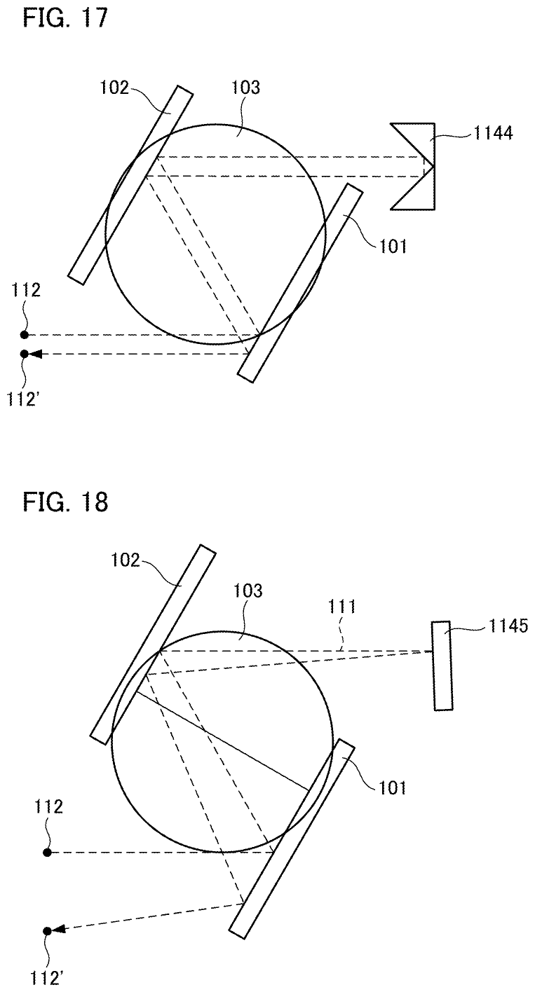

FIG. 17 is a diagram illustrating a fifteenth embodiment which is a specific example of the optical apparatus in FIGS. 11A to 11E.

The fifteenth embodiment is an example in which a third reflection surface 1144 that returns light from the second reflection surface 102 to the second reflection surface 102 is further provided in the above-described tenth to fourteenth embodiments. In this case, the light from the incidence point 112 is reflected by the third reflection surface 1144 and is returned back along substantially the same route to propagate to the emission point 112′. That is, the incidence point 112 and the emission point 112′ of the light are located at substantially the same position.

The third reflection surface 1144 is, for example, a mirror that has two perpendicular reflection surfaces. Thus, optical paths of incident light incident on the third reflection surface 1144 and reflected light reflected by the third reflection surface 1144 can be displaced. In this example, a direction in which the light is displaced by the third reflection surface 1144 is a direction parallel to the upper surface of the stage 103, but the present invention is not limited thereto. For example, the direction in which the light is displaced by the third reflection surface 1144 may be a direction perpendicular to the upper surface of the stage 103, as will be described in the nineteenth embodiment to be described below.

In this way, when the light is returned back only once using the third reflection surface 1144, the shift amount of the emission position is nearly doubled. When the shift amount of the emission position is constant, the range of the rotational angle θ of the stage 103 can be set to be small and a load on the galvano-motor can be reduced in this example. That is, in this example, as in the fourteenth embodiment, since the emission position can be shifted by a desired shift amount in accordance with the small rotational angle θ, the focus position can be controlled at a high speed and with high precision.

In this example, when a direction in which the light goes toward the third reflection surface 1144 is set as a forward path and a direction in which the light returns from the third reflection surface 1144 is set as a return path, the light may reciprocate a plurality of times along the forward path and the return path. In this case, a new reflection surface returning back the light may also be provided on the side of the incidence point 112.

### Sixteenth Embodiment

FIG. 18 is a diagram illustrating a sixteenth embodiment which is a specific example of the optical apparatus in FIGS. 11A to 11E.

The sixteenth embodiment is an example in which a third reflection surface 1145 that returns light from the second reflection surface 102 to the second reflection surface 102 is further provided in the above-described tenth to fourteenth embodiments. In this case, the light from the incidence point 112 is reflected by the third reflection surface 1145 and is returned back along substantially the same route to propagate to the emission point 112′. That is, the incidence point 112 and the emission point 112′ of the light are located at substantially the same position.

The third reflection surface 1145 is, for example, one planar mirror. However, a perpendicular line of the surface of the third reflection surface 1145 is not parallel to the optical path (optical axis) 111 of the light from the second reflection surface 102 and is inclined at a constant angle. Therefore, the optical paths of the incident light incident on the third reflection surface 1145 and the reflected light reflected by the third reflection surface 1145 can be displaced.

The direction in which the light is displaced by the third reflection surface 1145 may be a direction parallel to the upper surface of the stage 103, as illustrated in the drawing or may be a direction perpendicular to the upper surface of the stage 103 instead. The direction in which the light is displaced by the third reflection surface 1145 may be an inclination direction which is not parallel and perpendicular to the upper surface of the stage 103.

For example, when the light is displaced in the direction parallel to the upper surface of the stage 103, the surface of the third reflection surface 1145 may be inclined with respect to the optical path 111 by a predetermined amount in an x-y direction parallel to the upper surface of the stage 103. When the light is displaced in the direction perpendicular to the upper surface of the stage 103, the surface of the third reflection surface 1145 may be inclined with respect to the optical path 111 by a predetermined amount in the z direction perpendicular to the upper surface of the stage 103.

In this way, when the light is returned back only once using the third reflection surface 1145, the shift amount of the emission position is nearly doubled. When the shift amount of the emission position is constant, the range of the rotational angle θ of the stage 103 can be set to be small and a load on the galvano-motor can be reduced in this example. That is, in this example, as in the fourteenth embodiment, since the emission position can be shifted by a desired shift amount at the small rotational angle θ, the focus position can be controlled at a high speed and with high precision.

In this example, when a direction in which the light goes toward the third reflection surface 1145 is set as a forward path and a direction in which the light returns from the third reflection surface 1145 is set as a return path, the light may reciprocate a plurality of times along the forward path and the return path. In this case, a new reflection surface returning back the light may also be provided on the side of the incidence point 112.

### Seventeenth Embodiment

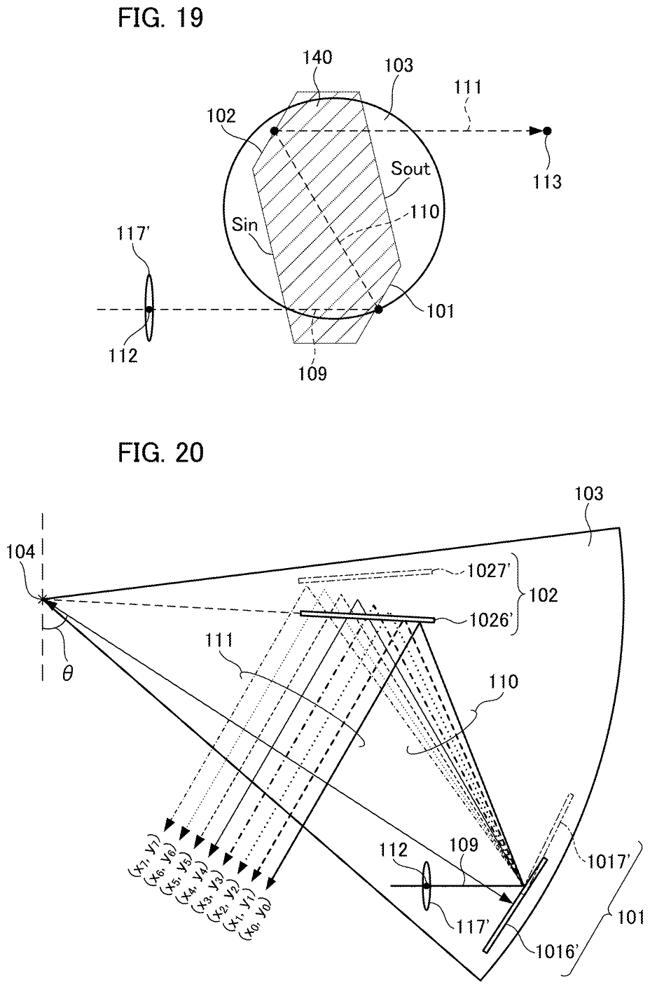

FIG. 19 is a diagram illustrating a seventeenth embodiment which is a specific example of the optical apparatus.

The seventeenth embodiment relates to a configuration of the first and second reflection surfaces 101 and 102. In the above-described tenth to sixteenth embodiments, the first and second reflection surfaces 101 and 102 are, for example, the mutually independent mirrors. However, the first and second reflection surfaces 101 and 102 are not limited thereto and may be inner surfaces of a predetermined member.

For example, as illustrated in the drawing, the first and second reflection surfaces 101 and 102 may be crystal surfaces of one crystal (for example, a glass material). That is, a crystal 140 has the first and second reflection surfaces 101 and 102 therein. The crystal 140 is fixed to the stage 103.

In this example, parallelism of the first and second reflection surfaces 101 and 102 can be improved through polishing work on the crystal 140. That is, when the first and second reflection surfaces 101 and 102 are independent mirrors and each mirror is fixed to the stage 103, parallelism of the first and second reflection surfaces 101 and 102 has to be adjusted, and thus the work may be complicated. Thus, when the crystal 140 is used, work for ensuring the parallelism of the first and second reflection surfaces 101 and 102 and work for mounting the first and second reflection surfaces 101 and 102 on the stage 103 can be separately performed.

Accordingly, according to this example, it is possible to efficiently perform work for assembling the optical apparatus.

When the crystal 140 is used as the first and second reflection surfaces 101 and 102, an end surface on which light is incident and an end surface Sₒᵤₜ from which the light is emitted are preferably coated to reduce reflection of the light.

The crystal 140 is preferably set so that angles formed between optical axis of light on the optical paths 109 and 111 and the end surfaces Sᵢₙ and Sₒᵤₜ are the so-called Brewster's angle. The Brewster's angle depends on a material of the crystal 140 and is, for example, about 60°. In this case, by setting about 60° as each of an angle formed between the optical axis of the light on the optical path 109 and the end surface Sᵢₙ and an angle formed between the optical axis of the light on the optical path 111 and the end surface Sₒᵤₜ it is possible to reduce a reflection loss on the end surfaces Sᵢₙ and Sₒᵤₜ.

### Eighteenth Embodiment

FIG. 20 is a diagram illustrating an eighteenth embodiment which is a specific example of the optical apparatus in FIGS. 11A to 11E.

The eighteenth embodiment is an example of a case in which the first reflection surface 101 and the second reflection surface 102 are nonparallel to each other. Here, although the first reflection surface 101 and the second reflection surface 102 are described as being nonparallel, it is necessary for the first reflection surface 101 and the second reflection surface 102 to face each other. That is, the light from the first reflection surface 101 can be reflected by the second reflection surface 102 in this disposition.

For example, an angle α formed between the first reflection surface 101 (1016′ and 1017′) and the second reflection surface 102 (1026′ and 1027′) is about 60°. The first reflection surface 1016′ and the second reflection surface 1026′ correspond to the case in which the rotational angle θ is 56°. The first reflection surface 1017′ and the second reflection surface 1027′ correspond to the case in which the rotational angle θ is 63°.

R1 is the length of the perpendicular line drawn from the rotational axis 104 to the first reflection surface 101 or the plane including the first reflection surface 101 and R2 is the length of the perpendicular line drawn from the rotational axis 104 to the second reflection surface 102 or the plane including the second reflection surface 102. In this case, the coordinates (x₀₁, y₀₁) of the intersection 105 and the coordinates (x₀₂, y₀₂) of the intersection 106 are expressed in Expressions (51) to (54) below.

$$\begin{matrix}{x}_{01} = {R}_{1} \times cos ( θ - \frac{π}{2} ) = {R}_{1} \times sin ( θ ) & ( 51 ) \\ {y}_{01} = {R}_{1} \times sin ( θ - \frac{π}{2} ) = - {R}_{1} \times cos ( θ ) & ( 52 ) \\ {x}_{02} = {R}_{2} \times cos ( θ + α + \frac{π}{2} ) = - {R}_{2} \times sin ( θ + α ) & ( 53 ) \\ {y}_{02} = {R}_{2} \times sin ( θ + α + \frac{π}{2} ) = {R}_{2} \times cos ( θ + α ) & ( 54 )\end{matrix}$$

When (x₁, y₁) are coordinates on the first reflection surface 101 and (x₂, y₂) are coordinates on the second reflection surface 102 the coordinates are described in Expressions (55) and (56) below.

y₁−y₀₁=(tan θ)×(x₁−x₀₁) (55)

y₂−y₀₂=(tan(θ+α))×(x₂−x₀₂) (56)

Here, (xₘ₁, yₘ₁) are a point at which light from the non-collimating optical system 400 is reflected by the first reflection surface 101 and (xₘ₂, yₘ₂) are a point at which light is reflected by the second reflection surface 102. In addition, yin is the y coordinate on the optical path 109 and (x_{BR}, y_{BR}) are coordinates on the optical path 110 between the first reflection surface 101 and the second reflection surface 102. In this case, coordinates on the optical path 110 between the first reflection surface 101 and the second reflection surface 102 can be described in Expression (57).

y_{BR}−yₘ₁=tan(2θ)×(x_{BR}−xₘ₁) (57)

In addition, (xₒ, yₒ) are coordinates on the optical path 111 between the second reflection surface 102 and the third reflection surface 114, coordinates on the optical path 111 can be described in Expression (58).

y_{O}−yₘ₂=tan(2α)×(x_{O}−xₘ₂) (58)

As understood from the above, a shift amount of the emission position depends not on the distances R1 and R2 between the rotational shaft 104 and the first and second reflection surfaces 101 and 102 but on the distance (R1+R2) between the first and second reflection surfaces 101 and 102. That is, when the distance between the first and second reflection surfaces 101 and 102 is shortened, the shift amount of the emission position can be decreased. In contrast, when the distance between the first and second reflection surfaces 101 and 102 is lengthened, the shift amount of the emission position can be increased.

In the foregoing configuration, for example, collimated light (parallel light) is incident on the condensing lens 117′ of a focal distance 100 mm. The rotational angle θ of the stage 103 is controlled within the range of 56° to 63°. The first reflection surface 101 is disposed at a position of 50 mm (R1=50) from the rotational shaft 104 and the second reflection surface 102 is disposed at a position of 0 mm (R2=0) from the rotational shaft 104. The second reflection surface 102 is inclined by α=−60° with respect to the first reflection surface 101. The lens 117′ is disposed at the position of 300 mm in the x direction and −25.7 mm in the y direction from the rotational shaft 104.

In the foregoing configuration, the shift amount of the emitted light emitted from the focus position shifter can be realized as 10.5 mm. That is, the focus position in the direction perpendicular to the optical axis can be controlled within the range of 10.5 mm from 0 mm (a reference point) by controlling the rotational angle θ of the stage 103. Further, the light emitted from each emission point (xᵢ, yᵢ) is parallel to each other. Accordingly, when the beam diameter of the light emitted from each emission point (xᵢ, yᵢ) is constant at a focus point and the focus position shifter is used in a processing device, an improvement in processing precision or the like can be realized.

In this example, the layout of the second reflection surface 102 may be decided so that reflection of the light by the second reflection surface 102 occurs nearer to the rotational shaft 104. In this case, a load on the galvano-motor is reduced, and thus the focus position can be controlled at a high speed.

### Nineteenth Embodiment

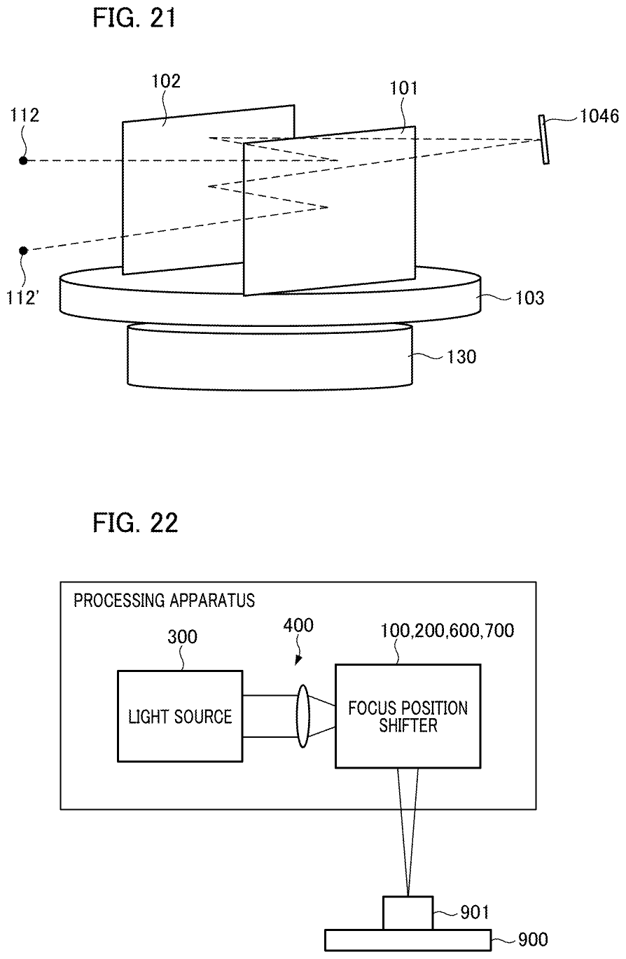

FIG. 21 is a diagram illustrating a nineteenth embodiment which is a specific example of the optical apparatus in FIGS. 11A to 11E.

The nineteenth embodiment is an example in which a third reflection surface 1146 returning light from the second reflection surface 102 to the second reflection surface 102 is further provided as in the above-described fifteenth embodiment. In this case, light from the incidence point 112 is reflected by the third reflection surface 1146 and is returned back along substantially the same route to propagate to the emission point 112′. That is, the incidence point 112 and the emission point 112′ of the light are located at substantially the same position.

The third reflection surface 1146 is, for example, a mirror that has two perpendicular reflection surfaces as in the above-described fifteenth embodiment. Here, in this example, a direction in which the light is displaced by the third reflection surface 1146 is a direction perpendicular to the upper surface of the stage 103. Thus, optical paths of incident light incident on the third reflection surface 1146 and reflected light reflected by the third reflection surface 1146 can be displaced.

In this way, when the light is returned back only once using the third reflection surface 1146, the shift amount of the emission position is nearly doubled. When the shift amount of the emission position is constant, the range of the rotational angle θ of the stage 103 can be set to be small and a load on the galvano-motor can be reduced in this example. That is, in this example, as in the fourteenth embodiment, since the emission position can be shifted by a desired shift amount in accordance with the small rotational angle θ, the focus position can be controlled at a high speed and with high precision.

In this example, when a direction in which the light goes toward the third reflection surface 1146 is set as a forward path and a direction in which the light returns from the third reflection surface 1146 is set as a return path, the light may reciprocate a plurality of times along the forward path and the return path. In this case, a new reflection surface returning back the light may also be provided on the side of the incidence point 112.

In the fifteenth embodiment, the direction in which the light is displaced by the third reflection surface 1144 is the direction parallel to the upper surface of the stage 103. In this case, the light going toward the third reflection surface 1144 and the light returning from the third reflection surface 1144 overlap each other when viewed on the lateral side of the stage 103, and the light going toward the third reflection surface 1144 and the light returning from the third reflection surface 1144 do not overlap each other when viewed on the upper side of the stage 103.

In the case of the nineteenth embodiment, however, the direction in which the light is displaced by the third reflection surface 1146 is a direction perpendicular to the upper surface of the stage 103. In this case, the light going toward the third reflection surface 1144 and the light returning from the third reflection surface 1146 do not overlap each other when viewed on the lateral side of the stage 103, and the light going toward the third reflection surface 1146 and the light returning from the third reflection surface 1144 overlap each other when viewed on the upper side of the stage 103.

Here, the fifteenth and nineteenth embodiments can also be combined. That is, the direction in which the light is displaced by the third reflection surface may be an inclination direction which is not parallel and perpendicular to the upper surface of the stage 103. In this case, the light going toward the third reflection surface 1144 and the light returning from the third reflection surface 1146 do not overlap each other when viewed on the lateral side of the stage 103, and the light going toward the third reflection surface 1146 and the light returning from the third reflection surface 1144 do not overlap each other when viewed on the upper side of the stage 103.

### Other Embodiments

The embodiments of the present invention have been described, but the present invention is not limited to these embodiments and can be modified in various forms within the scope of the gist of the present invention.

For example, in a processing device that performs work such as marking, punching, or welding using laser light, it is important to control a focus position of light from a laser oscillator with a high speed and with high precision. The above-described focus position shifter can be applied to such a processing device.

FIG. 22 illustrates an example of a processing device.

The processing device includes the light source 300, the non-collimating optical system 400 on which light from the light source 300 is incident, and the focus position shifter 100 or 200 that controls an optical path length of the light from the non-collimating optical system 400. An article 901 to be processed is disposed on a stage 900. By controlling a focus position of light on the article 901, it is possible to perform work such as marking, punching, or welding on the article 901.

Further, a microscope can be configured using the above-described focus position shifter. In this case, when a plane direction of a measurement target is an x-y direction and a depth direction thereof is a z direction, a condensing point can be scanned at a high speed on a specific x-z plane. For example, for a multi-photon microscope, a fluorescence microscope, or the like, a nonlinear effect, absorption by a fluorescent material or the like occurs in accordance with a focus position of light emitted to a measurement target. Therefore, by acquiring information at a focus position, 3-dimensional imaging can be performed.

So far, imaging is performed by scanning radiated light to a measurement target in the plane direction (the x-y direction), subsequently changing the depth direction (the z direction), and scanning the radiated light onto the plane at the positional. In the embodiment, however, since imaging can be performed at a high speed in the depth direction, movement or the like of substances from the surface of the measurement target in the depth direction can be observed.

An inspection device can be configured using the above-described focus position shifter.

For example, in an inspection device that inspects a surface state of an article, it is necessary to radiate radiated light at a constant radiation angle in order to avoid a variation in a beam diameter at the angle of the radiated light.

However, since an inspection device in the related art controls a focus position in a direction perpendicular to an optical axis using an f-θ lens, a beam diameter at a focus point may inevitably vary. Accordingly, when the above-described focus position shifter is used in such an inspection device, a focus position in a direction perpendicular to the optical axis can be controlled without varying the beam diameter at the focus point.

In each of the above-described embodiments, it is important for the first and second reflection surfaces 101 and 102 to rotate about the rotational shaft 104 in a state in which the relative arrangement between the first and second reflection surfaces 101 and 102 is maintained. Therefore, in this example, the stage 103 is provided and the first and second reflection surfaces 101 and 102 that face each other are fixed to the stage 103.

However, for example, according to a method in which the stage 103 is not used, the first and second reflection surfaces 101 and 102 can rotate about the rotational shaft 104 in a state in which the relative arrangement between the first and second reflection surfaces 101 and 102 is maintained. For example, a first motor that drives the first reflection surface 101 and a second motor that drives the second reflection surface 102 may be provided. Here, in this case, it is necessary for the control unit 120 to control rotation in a state in which the first and second motors are synchronized.

The control of the focus position in the direction perpendicular to the optical axis can be applied to a technology for shifting an optical path of light in the direction perpendicular to the optical path, that is, control of emission position of light in the direction. That is, for an optical device that does not include the non-collimating optical system 400 or an optical device that includes the non-collimating optical system 400 but does not control an emission position to control a focus position, each of the above-described embodiments can be applied as an optical device that merely shifts an optical axis of light.

According to the foregoing embodiments, it is possible to realize an optical device advantageous in that a focus position of light is controlled at a high speed and high precision. That is, the focus position can be controlled in the optical axis direction at a high speed and with high precision without moving a condensing lens. In addition, it is possible to control a focus position in a direction perpendicular to an optical axis at a high speed and with high precision without changing a beam diameter at a focus position.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-172135 filed on Sep. 14, 2018, which is hereby incorporated by reference herein in its entirety.

What is claimed is:

1. An optical apparatus controlling a focus position of light, comprising:
a first reflection surface configured to be rotatable about a rotational shaft and reflect the light;
a second reflection surface configured to be rotatable about the rotational shaft, face the first reflection surface, and reflect the light from the first reflection surface;
a third reflection surface that returns the light from the second reflection surface to the second reflection surface; and
a control unit configured to control a focus position in an optical axis direction of the light returned back to the first reflection surface from the third reflection surface via the second reflection surface by rotating the first and second reflection surfaces about the rotational shaft in a state in which a relative arrangement between the first and second reflection surfaces is maintained.

2. An optical apparatus controlling a focus position of light, comprising:
a first reflection surface configured to be rotatable about a rotational shaft and reflect the light;
a second reflection surface configured to be rotatable about the rotational shaft, face the first reflection surface, and reflect the light from the first reflection surface; and
a control unit configured to control a focus position in a direction perpendicular to an optical path of the light from the second reflection surface by rotating the first and second reflection surfaces about the rotational shaft in a state in which a relative arrangement between the first and second reflection surfaces is maintained.

3. The optical apparatus according to claim 1, further comprising:
a stage configured to be rotatable about the rotational shaft,
wherein the first and second reflection surfaces are fixed to the stage, and
wherein the control unit controls the focus position by changing a rotational angle of the stage.

4. The optical apparatus according to claim 1, wherein the rotational shaft is in a region between the first and second reflection surfaces.

5. The optical apparatus according to claim 1, wherein the rotational shaft is in a region other than a region between the first and second reflection surfaces.

6. The optical apparatus according to claim 1, wherein a size of the first reflection surface is different from a size of the second reflection surface.

7. The optical apparatus according to claim 1, wherein a length of a perpendicular line drawn from the rotational shaft to the first reflection surface or a plane including the first reflection surface is different from a length of a perpendicular line drawn from the rotational shaft to the second reflection surface or a plane including the second reflection surface.

8. The optical apparatus according to claim 1, wherein the first and second reflection surfaces are not disposed to be point-symmetric with respect to the rotational shaft.

9. The optical apparatus according to claim 1, wherein the light reciprocates between the first and second reflection surfaces a plurality of times.

10. The optical apparatus according to claim 1, wherein the third reflection surface reflects reflected light to the same optical path as an optical path of incident light.

11. The optical apparatus according to claim 1, further comprising:
a fourth reflection surface configured to extract the light returned back from the third reflection surface to the first reflection surface via the second reflection surface.

12. The optical apparatus according to claim 11, further comprising:
a fifth reflection surface configured to return the light returned by the third reflection surface and reflected by the first reflection surface, to the first reflection surface,
wherein the third and fifth reflection surfaces reflect the reflected light to an optical path different from an optical path of incident light, and
wherein the fourth reflection surface extracts the light returned back to the second reflection surface from the fifth reflection surface via the first reflection surface.

13. The optical apparatus according to claim 1, wherein the light is changed into convergent light or diffused light by a non-collimating optical system before the light is reflected by the first reflection surface.

14. The optical apparatus according to claim 2, wherein the light is changed into convergent light by a non-collimating optical system after the light is reflected by the first and second reflection surfaces.

15. The optical apparatus according to claim 1, wherein the first and second reflection surfaces are nonparallel.

16. The optical apparatus according to claim 1, wherein the second reflection surface is disposed closer to the rotational shaft than the first reflection surface.

17. The optical apparatus according to claim 1, wherein the control unit drives the first and second reflection surfaces using a galvano-motor.

18. The optical apparatus according to claim 1, wherein the control unit drives the first and second reflection surfaces using a rotational motor that is able to rotate unidirectionally.

19. An optical apparatus controlling the focus position of light, comprising:
a first reflection surface configured to be rotatable about a rotational shaft and reflect light;
a second reflection surface configured to be rotatable about the rotational shaft, face the first reflection surface, and reflect the light from the first reflection surface; and
a control unit configured to shift an optical path of the light from the second reflection surface in a direction perpendicular to the optical path by rotating the first and second reflection surfaces about the rotational shaft in a state in which a relative arrangement between the first and second reflection surfaces is maintained.

20. A processing apparatus comprising:
the optical apparatus according to claim 1; and
a light source configured to generate light incident on the optical apparatus,
wherein an article disposed at a focus position is processed by controlling the focus position.

21. A processing apparatus comprising:
the optical apparatus according to claim 2; and
a light source configured to generate light incident on the optical apparatus,
wherein an article disposed at a focus position is processed by controlling the focus position.

22. A processing apparatus comprising:
the optical apparatus according to claim 19; and
a light source configured to generate light incident on the optical apparatus,
wherein an article disposed at a focus position is processed by controlling the focus position.
